(19) United States
(12) Patent Application Publication
(10) Pub. No.: US 2025/0094481 A1
(43) Pub. Date: Mar. 20, 2025

(54) ELECTRONIC DEVICE, METHOD, AND NON-TRANSITORY COMPUTER-READABLE STORAGE MEDIUM FOR PROCESSING TEXT CONTAINED WITHIN TEXT INPUT PORTION OF USER INTERFACE

(71) Applicant: Samsung Electronics Co., Ltd., Suwon-si (KR)

(72) Inventors: Hyunkyoung KIM, Suwon-si (KR); Woonghee PARK, Suwon-si (KR); Minjung SOHN, Suwon-si (KR); Jinbong RYU, Suwon-si (KR); Younghak OH, Suwon-si (KR)

(21) Appl. No.: 18/964,184

(22) Filed: Nov. 29, 2024

Related U.S. Application Data
(63) Continuation of application No. PCT/KR2023/004827, filed on Apr. 10, 2023.

(30) Foreign Application Priority Data
May 29, 2022 (KR) 10-2022-0065727
Jun. 28, 2022 (KR) 10-2022-0078983

(51) Int. Cl. G06F 16/483; G06F 3/0481; G06F 40/279

(52) U.S. Cl. CPC G06F 16/483; G06F 3/0481; G06F 40/279

(57) ABSTRACT

An electronic device is provided. The electronic device includes a display, memory storing one or more computer programs, and one or more processors communicatively coupled to the display and the memory, wherein the one or more computer programs include computer-executable instructions that, when executed by the one or more processors individually or collectively, cause the electronic device to, based on a recognition of media content stored in the electronic device, obtain information regarding the media content, identify an event providing the media content from a first software application to a second software application, identify attribute information of a text input portion in a user interface of the second software application, obtain text indicating at least a portion of the information based on the attribute information, and display, via the display, a text input portion including the text, with the media content, in the user interface of the second software application executed in response to the event.

### CROSS-REFERENCE TO RELATED APPLICATION(S)

This application is a continuation application, claiming priority under 35 U.S.C. § 365 (c), of an International application No. PCT/KR2023/004827, filed on Apr. 10, 2023, which is based on and claims the benefit of a Korean patent application number 10-2022-0065727, filed on May 29, 2022, in the Korean Intellectual Property Office, and of a Korean patent application number 10-2022-0078983, filed on Jun. 28, 2022, in the Korean Intellectual Property Office, the disclosure of each of which is incorporated by reference herein in its entirety.

### BACKGROUND

### 1. Field

The disclosure relates to an electronic device, a method, and a non-transitory computer-readable storage medium for processing text contained within a text input portion of a user interface.

### 2. Description of Related Art

An electronic device may display a user interface including a text input portion through a display of the electronic device or a display of an external electronic device. For example, the text input portion may be a space in which text identified based on a user input is inputted. For example, a virtual keyboard or a handwritten input field may be used to input the text to the text input portion.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, method, and non-transitory computer-readable storage medium for processing text contained within text input portion of user interface.

Additional aspects will be set forth in part in the description which follows and, in part, will be apparent from the description, or may be learned by practice of the presented embodiments.

An electronic device is described. The electronic device may comprise a display and a processor. The processor may be configured to, based on a recognition of media content stored in the electronic device, obtain information regarding the media content. The processor may be configured to identify an event providing the media content from a first software application to a second software application. The processor may be configured to identify attribute information of a text input portion in a user interface of the second software application. The processor may be configured to obtain text indicating at least a portion of the information, based on the attribute information. The processor may be configured to display, via the display, a text input portion including the text, with the media content, in the user interface of the second software application executed in response to the event.

A method for an electronic device including a display is described. The method may comprise, based on a recognition of media content stored in the electronic device, obtaining information regarding the media content. The method may comprise identifying an event providing the media content from a first software application to a second software application. The method may comprise identifying attribute information of a text input portion in a user interface of the second software application. The method may comprise obtaining text indicating at least a portion of the information, based on the attribute information. The method may comprise displaying, via the display, a text input portion including the text, with the media content, in the user interface of the second software application executed in response to the event.

A non-transitory computer readable storage medium including one or more programs is described. The one or more programs may comprise instructions which, when executed by a processor of an electronic device including a display, cause the electronic device to, based on a recognition of media content stored in the electronic device, obtain information regarding the media content. The one or more programs may comprise instructions which, when executed by the processor of the electronic device, cause the electronic device to identify an event providing the media content from a first software application to a second software application. The one or more programs may comprise instructions which, when executed by the processor of the electronic device, cause the electronic device to identify attribute information of a text input portion in a user interface of the second software application. The one or more programs may comprise instructions which, when executed by the processor of the electronic device, cause the electronic device to obtain text indicating at least a portion of the information, based on the attribute information. The one or more programs may comprise instructions which, when executed by the processor of the electronic device, cause the electronic device to display, via the display, a text input portion including the text, with the media content, in the user interface of the second software application executed in response to the event.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an exemplary electronic device.

FIG. 2 illustrates an example of text in a text input portion displayed with media content.

FIG. 3 illustrates an example of adaptively obtaining text included in a text input portion displayed with media content according to attribute information.

FIG. 4 illustrates an example of obtaining text included in a text input portion based on resources used for searching media content.

FIG. 5 illustrates an example of obtaining text included in a text input portion based on other media content displayed with media content.

FIG. 6 illustrates an example of obtaining text included in a text input portion, based on a name of a folder including an executable object for executing a software application used to display media content.

FIG. 7 illustrates an example of displaying a plurality of items associated with text in a text input portion displayed with media content.

FIG. 8 illustrates an example of displaying a plurality of texts to be included in a text input portion.

FIG. 9 illustrates an example of displaying an item for text in a text input portion based on a classification of a software application associated with media content.

FIG. 10 illustrates an example of displaying text in a text input portion based on upper categories of categories of media content.

FIG. 11 illustrates an example of displaying additional items based on a change in text in a text input portion displayed with media content.

FIG. 12 illustrates an example of displaying items respectively indicating categories together with text in a text input portion.

FIG. 13 illustrates an example of representation of text in a text input portion corresponding to representation of media content.

FIG. 14 illustrates an example of obtaining text based on a relationship between a user associated with media content and a user of an external electronic device.

FIG. 15 illustrates an example of identifying whether to include privacy information in text to be included in a text input portion.

FIG. 16 illustrates an example of displaying text including information regarding a writer of media content in a text input portion.

FIG. 17 illustrates an example of identifying a type of text to be included in a text input portion based on a type of a software application.

FIG. 18 illustrates an example of displaying media content corresponding to text included in a text input portion.

FIG. 19 illustrates an example of transferring information regarding media content to an external electronic device.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

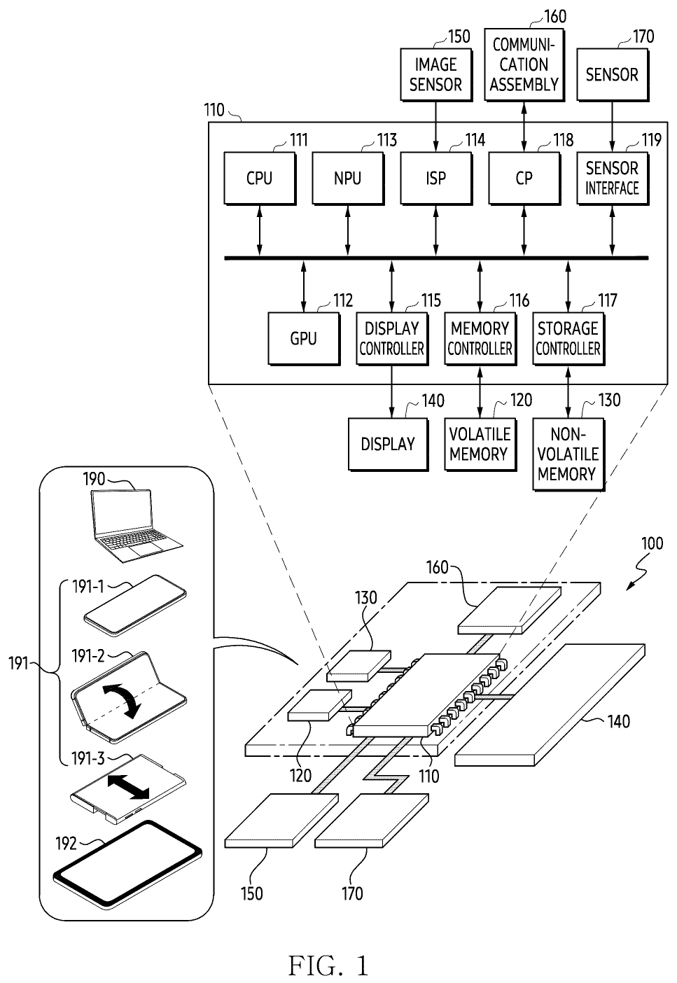

FIG. 1 illustrates an exemplary electronic device.

Referring to FIG. 1, an electronic device 100 may be one of various types of mobile devices such as a notebook 190, smartphones 191 with various form factors (e.g., a bar-type smartphone 191-1, a foldable-type smartphone 191-2, or a rollable-type smartphones 191-3), a tablet 192, a cellular phone, and other similar computing devices. The components shown in FIG. 1, their relationships, and their functions are merely exemplary and do not limit implementations described or claimed in this document. The electronic device 100 may be referred to as a user device, a multifunctional device, or a portable device.

The electronic device 100 may include components including a processor 110, volatile memory 120, nonvolatile memory 130, a display 140, an image sensor 150, communication circuitry 160, and a sensor 170. The components are merely exemplary. For example, the electronic device 100 may include another component (e.g., a power management integrated circuit (PMIC), audio processing circuitry, or an input/output interface). For example, some components may be omitted from the electronic device 100.

The processor 110 may be implemented with one or more integrated circuit (IC) chips and may execute various data processes. For example, the processor 110 may be implemented as a system on chip (SoC) (e.g., a single chip or chipset). The processor 110 may include sub-components including a central processing unit (CPU), a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. The sub-components are merely exemplary. For example, the processor 110 may further include other sub-components. For example, some sub-components may be omitted from the processor 110.

The CPU 111 may be configured to control the sub-components based on execution of instructions stored in the volatile memory 120 and/or the nonvolatile memory 130. The GPU 112 may include circuitry configured to execute parallel operations (e.g., rendering). The NPU 113 may include circuitry configured to execute operations (e.g., convolution computation) for an artificial intelligence model. The ISP 114 may include circuitry configured to process a raw image obtained through the image sensor 150 in a suitable format for a component in the electronic device 100 or a sub-component in the processor 110. The display controller 115 may include circuitry configured to process an image obtained from the CPU 111, the GPU 112, the ISP 114, or the volatile memory 120 in a suitable format for the display 140. The memory controller 116 may include circuitry configured to control reading data from the volatile memory 120 and writing data to the volatile memory 120. The storage controller 117 may include circuitry configured to control reading data from the nonvolatile memory 130 and writing data to the nonvolatile memory 130. The CP 118 may include circuitry configured to process data obtained from a sub-component in the processor 110 in a suitable format for transmitting the data to another electronic device through the communication circuit 160, or process data obtained through the communication circuit 160 from another electronic device in a suitable format for processing the sub-component. The sensor interface 119 may include circuitry configured to process data, obtained through the sensor 170, regarding a state of the electronic device 100 and/or a state around the electronic device 100 in a suitable format for a sub-component in the processor 110.

The processor 110 may display media content stored in the volatile memory 120 and/or the nonvolatile memory 130 through the display 140. For example, the media content may be displayed within a user interface of a software application. For example, the term “media content” used in this document may include data, digital code, text, sound, audio, image, graphics, text, video, or any other similar material. For example, the term “media content” used in this document may further include multimedia content in which two or more different media content are combined. For example, in this document, displaying the media content may include displaying the media content, displaying a visual object representing the media content, and displaying an executable object for displaying the media content.

For example, the user interface may further include a text input portion. For example, the text input portion may be a space to which text identified based on a user input is inputted. The text input portion may be linked with a virtual keyboard or a handwriting input field. The text input portion may include text identified based on a user input received through the virtual keyboard or the handwriting input field.

For example, the media content may be displayed with the text input portion. For example, the media content may be displayed within the text input portion. For example, the media content may be displayed within another region of the user interface distinct from a region of the user interface in which the text input portion is displayed. However, it is not limited thereto.

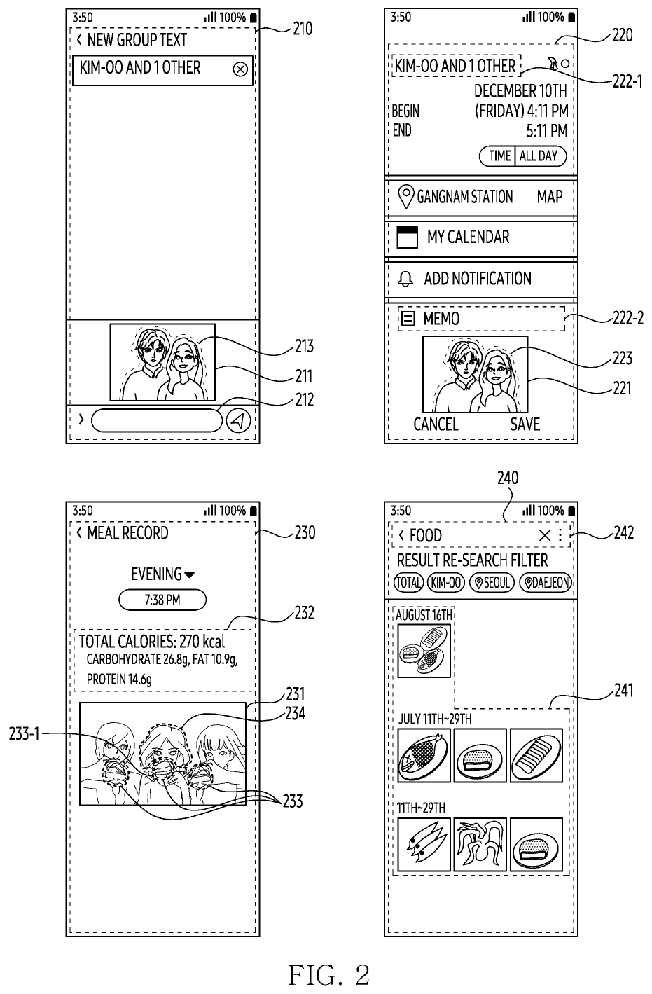

For example, the text input portion displayed with the media content may be used to input text including information regarding the media content. For example, the text may be illustrated through a description of FIG. 2.

FIG. 2 illustrates an example of text in a text input portion displayed with media content.

Referring to FIG. 2, a user interface 210 of a software application used for transmitting and receiving a message may include media content 211 and a text input portion 212. For example, the text input portion 212 may be used to input a message including text to be provided to a user of an external electronic device. For example, text included in, inputted to, or inserted into the text input portion 212 based on a user input may include information regarding the media content 211. For example, the text may be included in the text input portion 212 according to user input, in order to provide the information to a user of an external electronic device. For example, the text may include a word derived from the media content 211. For example, the text may include at least one keyword of the media content 211. For example, the text may include a word indicating at least one category of the media content 211. For example, the text may include a word indicating or representing a place where the media content 211 is obtained. For example, the text may include a word indicating or representing a time when the media content 211 is obtained. For example, the text may include a word indicating or representing at least one visual object 213 within the media content 211. For example, the text may include a word indicating or representing a context associated with the media content 211. However, it is not limited thereto.

For example, a user interface 220 of a software application used to manage a schedule may include media content 221, a text input portion 222-1, and a text input portion 222-2. For example, the text input portion 222-1 may be used to input a title of a schedule to be registered. For example, text included in, inputted to, or inserted into the text input portion 222-1 based on a user input may include information regarding the media content 221. For example, the text may include a word indicating or representing at least one user's name indicated by at least one visual object 223 within the media content 221. However, it is not limited thereto. For example, the text input portion 222-2 may be used to input a memo associated with the schedule to be registered. For example, text included in, inputted to, or inserted into the text input portion 222-2 based on a user input may include information regarding the media content 221. The text may include more detailed information than the text included in the text input portion 222-1. However, it is not limited thereto.

For example, the user interface 230 of a software application used for health management may include media content 231 and a text input portion 232. For example, the text input portion 232 may be used to input calories of food consumed by a user. For example, text included in, inputted to, or inserted into the text input portion 232 based on a user input may include information regarding the media content 231. For example, the text may include a word indicating or representing calories of food indicated by one of the visual objects 233 within the media content 231. For example, the text may include a word indicating or representing calories of food corresponding to a visual object 233-1, consumed by a user indicated by a visual object 234 within the media content 231. However, it is not limited thereto.

For example, a user interface 240 of a software application used for displaying and/or searching media content may include at least one media content 241 and a text input portion 242. For example, the text input portion 242 may be used to input at least one keyword used to identify or search for the at least one media content 241 from among a plurality of media content capable of displaying using the software application. For example, a text included in, inputted to, or inserted into the text input portion 242 based on a user input may include information regarding the at least one media content 241. For example, the text may include a word indicating or representing a category of the at least one media content 241. For example, the text may include a word indicating or representing a tag set or identified for the at least one media content 241. However, it is not limited thereto.

Referring back to FIG. 1, as illustrated through the description of FIG. 2, the text included in the text input portion displayed with the media content may be associated with the media content. For example, since the text is associated with the media content, the text may be obtained through analysis regarding the media content. For example, the text may be obtained by recognizing the media content. For example, the text may be obtained by identifying resources used to obtain the media content. For example, the text may be obtained by identifying resources used to identify or search for the media content from among a plurality of media content. For example, the text may be obtained by identifying at least one category of the media content. For example, the text may be obtained by identifying at least one keyword of the media content. For example, the text may be obtained by identifying at least one tag of the media content. For example, the text may be obtained by identifying a service provided through a software application used to display the media content. For example, the text may be obtained by identifying a name of a region (e.g., folder) including an executable object for executing the software application. For example, the text may be obtained by identifying a name of at least one classification including the media content among classifications defined in the software application. For example, the text may be obtained by identifying other text (or other media content) displayed with the media content. For example, the text may be obtained by identifying metadata of the media content. However, it is not limited thereto.

For example, since text to be included within the text input portion is associated with the media content, a user input to include the text within the text input portion may be simplified through the analysis regarding the media content. For example, obtaining or identifying text to be included in the text input portion based on the analysis may reduce the number of user inputs to respectively input characters constituting the text. For example, obtaining text to be included in the text input portion based on the analysis may enhance the user experience associated with the text input portion.

For example, the processor 110 may obtain the text by executing at least a portion of operations exemplified through a table of contents “1. Method of obtaining text” below. For example, the electronic device 100 may have an ability executing at least a portion of the operations illustrated through the table of contents “1. Method of obtaining text” below.

### 1. Method of Obtaining Text

### 1.1 Method of Obtaining Text Based on Resources Used for Searching Media Content

For example, the processor 110 may obtain the text to be included in the text input portion based on resources used to identify or search for the media content displayed with the text input portion, from among a plurality of media contents capable of being provided through the electronic device 100. For example, the processor 110 may obtain the text including words respectively indicating or respectively representing the resources. For example, the processor 110 may identify a condition, a word, a character, a category, and/or other media content used to identify or search for the media content, and obtain the text based on the condition, the word, the character, and/or the other media content. For example, the resources, such as the condition, the word, the character, and/or the other media content, may be inputted for the identification of the media content through a user input for selecting at least one item, from among items respectively indicating a plurality of candidate resources. For example, the plurality of candidate resources may be recommended resources for the search, identified based on an autocomplete or autocomplete function. For example, the plurality of candidate resources may be recommended resources for the search, identified based on a use history of the electronic device 100. For example, the resources may be inputted through a user input for the identification of the media content. However, it is not limited thereto.

1.2 Method of Obtaining Text Based on a Category and/or a Keyword of Media Content

For example, the processor 110 may identify at least one category of the media content and/or at least one keyword of the media content based on recognition of the media content displayed with the text input portion or to be displayed with the text input portion, and obtain the text to be included in the text input portion based on the at least one category and/or the at least one keyword. For example, the processor 110 may obtain the text by identifying at least one category including a place (e.g., a place where the media content is obtained) identified based on metadata of the media content and/or at least one keyword indicating the place. For example, the processor 110 may obtain the text, by identifying at least one category including a place (e.g., a place where the media content represents) identified based on feature points in the media content and/or at least one keyword indicating the place. For example, the processor 110 may obtain the text, by identifying at least one category including date information (e.g., date information on which the media content is obtained) identified based on metadata of the media content and/or feature points in the media content, and/or at least one keyword indicating the date information. For example, the processor 110 may obtain the text, by identifying at least one category including an external object corresponding to a visual object in the media content identified based on recognition of the media content and/or at least one keyword indicating the external object. For example, the processor 110 may obtain the text by identifying at least one category including a state of a visual object in the media content identified based on recognition of the media content and/or at least one keyword indicating the state. For example, the processor 110 may obtain the text by identifying at least one category including a context identified based on recognition of the media content and/or at least one keyword indicating the context. For example, the processor 110 may obtain the text by identifying at least one category including a theme of the media content identified based on recognition of the media content and/or at least one keyword indicating the theme. For example, the processor 110 may obtain the text including a word indicating the at least one category and/or the at least one keyword. However, it is not limited thereto.

1.3 Method of Obtaining Text Based on Other Media Content Displayed with Media Content

For example, the media content may be provided from a first software application to a second software application. For example, the processor 110 may display the media content provided from the first software application to the second software application within a user interface of the second software application, together with the text input portion. For example, the processor 110 may identify other media content displayed with the media content within a user interface of the first software application, based on an event in which the media content is provided from the first software application to the second software application. For example, the other media content may be identified based on processing executed before identifying the event. For example, the other media content may be identified based on processing executed in response to the event. For example, a type of the other media content may be the same as a type of the media content. For example, the type of the other media content may be different from the type of the media content. For example, the media content may be an image, and the other media content may be text. For example, the processor 110 may obtain the text to be included in the text input portion based on information regarding the other media content. For example, the information regarding the other media content may be obtained by executing at least a portion of operations exemplified through other sub-table of contents of the table of contents 1. with respect to the other media content. For example, since the other media content displayed with the media content may be associated with the media content, the processor 110 may obtain the text to be included in the text input portion based on the other media content. For example, when the other media content is text including words, the processor 110 may obtain the text including at least a portion of the words. However, it is not limited thereto.

### 1.4 Method of Obtaining Text Based on a Name of a Folder Including an Executable Object for a Software Application Obtaining or Providing Multimedia Content

For example, the media content may be obtained through the first software application or displayed on the display 140 through the first software application. For example, the processor 110 may display the media content with the text input portion, within a user interface of the second software application different from the first software application. For example, the processor 110 may identify the first software application used to obtain the media content or display the media content, based on an event for displaying the media content within the user interface of the second software application. For example, the processor 110 may identify a location of an executable object (e.g., icon) for executing the identified first software application. For example, the processor 110 may identify the executable object included in a first folder among folders defined in the electronic device 100, based on the identification. For example, the processor 110 may obtain the text to be included in the text input portion based on a name of the first folder. For example, the name of the first folder may be identified based on processing executed before identifying the event. For example, the name of the first folder may be identified based on processing executed in response to the event. For example, the processor 110 may obtain the text including the name of the first folder or a word indicating the name of the first folder. However, it is not limited thereto.

1.5 Method of Obtaining Text Based on Information Obtained Through Another Software Application Distinct from a Software Application Used to Display Media Content

For example, the processor 110 may identify an event displaying the media content together with the text input portion, within the user interface of the first software application. For example, the processor 110 may identify the information regarding the media content based on the event. For example, the information regarding the media content may be identified based on processing executed before identifying the event. For example, the information regarding the media content may be identified based on processing executed in response to the event. For example, the information regarding the media content may be obtained through at least a portion of operations exemplified through other sub-table of contents of the table of contents 1. For example, the processor 110 may identify whether the information regarding the media content is associated with information obtained through software applications different from the first software application. For example, the processor 110 may identify that the information regarding the media content is associated with information obtained through a second software application different from the first software application. For example, the information regarding the media content being associated with the information obtained through the second software application may be identified based on processing executed before identifying the event. For example, the information regarding the media content being associated with the information obtained through the second software application may be identified based on processing executed in response to the event. For example, when the first software application is a software application for transmitting and receiving a message, and the second software application is a software application for managing a schedule, the processor 110 may identify that the second software application includes contents (e.g., the information obtained through the second software application) regarding a first schedule on date (e.g. the information regarding the media content) on which the media content is obtained. For example, the processor 110 may obtain the text to be included in the text input portion based on the information obtained through the second software application, based on the identification. For example, the processor 110 may obtain the text including at least one word to provide at least a portion of the contents regarding the first schedule. However, it is not limited thereto.

1.6 Method for Obtaining Text Based on a Category and/or a Keyword Including at Least a Portion of Objects within Media Content

For example, the processor 110 may identify an event that displays the media content together with the text input portion within a user interface of a software application. For example, the processor 110 may identify categories (and/or keywords) of a plurality of objects configuring the media content, based on the event. For example, the processor 110 may identify a category (and/or keyword) including the most objects of the media content from among the categories (and/or the keywords). For example, the category (and/or the keyword) may be identified based on processing executed before identifying the event or processing executed in response to the event. For example, the processor 110 may obtain the text to be included in the text input portion, based on the identified category (and/or the keyword). For example, the processor 110 may obtain the text including a word indicating or representing the identified category (and/or the keyword). However, it is not limited thereto. In an embodiment, the operations exemplified through the table of contents 1.6 may be included within the operations exemplified through the table of contents 1.2. However, it is not limited thereto.

1.7 Method for Obtaining Text Based on a State of at Least a Portion of Objects within Media Content

For example, the processor 110 may identify an event that displays the media content together with the text input portion within a user interface of a software application. For example, the processor 110 may identify a state of each of objects within the category (and/or the keyword) (e.g., a category including the most objects of the media content), exemplified through the table of contents 1.6, based on the event. For example, the state of each of the objects may be identified based on processing executed before identifying the event or processing executed in response to the event. For example, the state of each of the objects may be identified based on feature points of each of the objects within the category (and/or the keyword). For example, the processor 110 may obtain the text to be included in the text input portion, based on the identified state. For example, the processor 110 may obtain the text including a word indicating or representing the state of each of the objects. However, it is not limited thereto. In an embodiment, the operations exemplified through the table of contents 1.7 may be included within the operations exemplified through the table of contents 1.6. However, it is not limited thereto.

1.8 Method for Obtaining Text Based on at Least One Object Located within a Predetermined Region of Media Content

For example, the processor 110 may identify an event that displays the media content together with the text input portion within a user interface of a software application. For example, the processor 110 may identify at least one object located within a predetermined region of the media content, based on the event. For example, the at least one object may be identified based on processing executed before identifying the event or processing executed in response to the event. For example, when the media content is an image, the processor 110 may identify at least one visual object located within a center region of the media content as the at least one object. For example, when the media content is a document, the processor 110 may identify text included in the header or footer of the document as the at least one object. However, it is not limited thereto. For example, the processor 110 may obtain the text to be included in the text input portion, based on information regarding the at least one object. For example, the information regarding the at least one object may be identified based on processing executed before identifying the event or processing executed in response to the event. For example, the information regarding the at least one object may be obtained by executing at least a portion of the operations exemplified through other sub-table of contents of the table of contents 1. with respect to the at least one object. For example, the processor 110 may obtain the text including a word indicating or representing a keyword of the at least one object or a category of the at least one object.

### 1.9 Method for Obtaining Text Based on Classification of a Software Application Including Media Content

For example, the media content may be included in a first classification (or a first storage region) among classifications (or storage regions) defined within the first software application. For example, the media content included in the first classification (or the first storage region) may be provided from the first software application to the second software application. For example, the processor 110 may display the media content provided from the first software application to the second software application together with the text input portion, within a user interface of the second software application. For example, the processor 110 may identify the first classification (or the first storage region) including the media content, based on an event providing the media content from the first software application to the second software application. For example, the first classification (or the first storage region) may be identified based on processing executed before identifying the event or processing executed in response to the event. For example, the processor 110 may obtain the text based on the first classification (or the first storage region). For example, the processor 110 may obtain the text including a word indicating or representing the first classification (or the first storage region). However, it is not limited thereto.

1.10 Method of Obtaining Text Based on Privacy Information within Media Content

For example, the media content may include privacy information. For example, when the text to be included in the text input portion is obtained based on the information regarding the media content, the text may include the privacy information. For example, the privacy information may include information indicating a location associated with a user, information indicating a user's name, user identification information, user physical information, and/or user phone number. However, it is not limited thereto. For example, the processor 110 may obtain the information regarding the media content through at least a portion of the operations exemplified through other sub-table of contents of the table of contents 1. and identify that the privacy information is included in the obtained information. For example, the processor 110 may remove the privacy information from the obtained information based on the identification, and obtain the text to be included in the text input portion based on the information from which the privacy information has been removed. For example, the processor 110 may obtain the text to be included in the text input portion, in response to an event for displaying the media content within a user interface of a software application together with the text input portion. For example, the processor 110 may identify whether a service provided through the software application is a service exposing the privacy information, obtain the text from which the privacy information has been removed on a condition that the service is a service exposing the privacy information, and obtain the text including the privacy information on a condition that the service is a service not exposing the privacy information. For example, whether a service provided through the software application is a service exposing the privacy information may be identified based on processing executed before identifying the event or processing executed in response to the event. However, it is not limited thereto.

### 1.11 Method of Obtaining Text Based on a Service Provided Through a Software Application

For example, text to be included in the text input portion displayed with the media content within a user interface of a software application may correspond to a context in which the media content is displayed through the software application. For example, the processor 110 may identify a service provided through the software application, based on an event in which the media content is displayed with the text input portion, so that the text corresponds to the context. For example, the processor 110 may obtain the text to be included in the text input portion based on the service. For example, the processor 110 may identify data corresponding to the service from the information regarding the media content, and obtain the text based on the data. For example, the data may be identified based on processing executed before identifying the event or processing executed in response to the event. However, it is not limited thereto.

1.12 Method for Obtaining Text Based on a Relationship Between a User Associated with Media Content and a User of an External Electronic Device

For example, the processor 110 may display the text input portion, together with the media content, within a user interface of a software application used to transmit the media content to an external electronic device. For example, the software application may be a software application used to transmit and receive a message, which provides the user interface 210 illustrated in FIG. 2. For example, the processor 110 may identify a relationship between a user of the external electronic device and a user associated with the media content, based on an event displaying the media content within the user interface of the software application. For example, the user associated with the media content may be obtained by executing at least a portion of the operations exemplified through other sub-table of contents of the table of contents 1. with respect to the media content. For example, the user associated with the media content may be identified based on processing executed before identifying the event or processing executed in response to the event. For example, the processor 110 may identify the user of the external electronic device by using another software application distinct from the software application. For example, the other software application may be a software application used for managing a contact. For example, the processor 110 may identify a relationship between the user associated with the media content and the user of the external electronic device through the other software application. However, it is not limited thereto. For example, the processor 110 may obtain the text to be included in the text input portion, based on the information regarding the media content. For example, the text may be obtained by executing at least a portion of the operations exemplified through other sub-table of contents of the table of contents 1. For example, the processor 110 may identify whether the text includes at least one word indicating the user associated with the media content and/or the user of the external electronic device, before including the text within the text input portion. For example, the processor 110 may change the at least one word based on the relationship between the user associated with the media content and the user of the external electronic device, on a condition that the text includes the at least one word. For example, in case that the relationship between the user of the media content and the user of the external electronic device is father and daughter, the processor 110 may change the user's name of the external electronic device, included in the text, to the word “daughter”. The processor 110 may obtain the text including the at least one word changed based on the relationship. However, it is not limited thereto.

### 1.13 Method of Obtaining Text Based on an Attribute of a Text Input Portion

For example, the text input portion displayed with the media content within a user interface of a software application may have an attribute corresponding to a function or service provided through the software application.

For example, in case that the software application is a software application for transmitting and receiving a message, the text input portion may be a field that provides a function for inputting a recipient of a message transmitted through the software application. For example, the text input portion may have an attribute (or function) linked to a software application for a contact. For example, the processor 110 may identify a user associated with the media content from the information regarding the media content, identified through at least a portion of the operations exemplified through other sub-table of contents of the table of contents 1. The processor 110 may identify a word indicating or representing the user, by searching the software application for the contact using data regarding the identified user. The processor 110 may obtain the text including the word.

For example, in case that the software application is a software application for transmitting and receiving a message, the text input portion may be a field for inputting a message. For example, text to be included in the text input portion may be a description regarding the media content. For example, the text input portion may have an attribute associated with a context or state represented through the media content. For example, the processor 110 may identify the context or state represented through the media content from the information regarding the media content, identified through at least a portion of the operations exemplified through other sub-table of contents of the table of contents 1. The processor 110 may obtain the text including at least one word indicating or representing the context or the state. For example, the text input portion may have the maximum number of characters capable of being inputted into the text input portion. For example, the processor 110 may obtain the text including the at least one word, based on the maximum number of characters.

For example, in case that the software application is a software application for transmitting and receiving an email, the text input portion may be a field that provides a function for inputting a recipient of an email transmitted through the software application. For example, the text input portion may have an attribute linked to the software application for the contact. For example, the processor 110 may identify a user associated with the media content from the information regarding the media content, identified through at least a portion of the operations exemplified through other sub-table of contents of the table of contents 1. The processor 110 may identify a word indicating or representing the user, by searching the software application for the contact using data regarding the identified user. The processor 110 may obtain the text including the word. For example, the text obtained to include in a text input portion within a user interface of the software application for transmitting and receiving an email may be different from text obtained to include in a text input portion within a user interface of the software application for sending and receiving a message. For example, the text obtained to include in a text input portion of a user interface of the software application for transmitting and receiving an email may include the user's email address obtained through the software application for the contact, and text obtained to include in a text input portion in a user interface of the software application for transmitting and receiving a message may include the user's phone number obtained through the software application for the contact.

For example, in case that the software application is a software application for transmitting and receiving an email, the text input portion may be a field that provides a function for inputting a title or content of the email transmitted through the software application. For example, in case that the text input portion is a field that provides a function for inputting a title of the email, text to be included in the text input portion may be a theme of the media content. For example, the processor 110 may identify the theme of the media content from the information regarding the media content, identified through at least a portion of the operations exemplified through other sub-table of contents of the table of contents 1. The processor 110 may obtain the text including at least one word indicating or representing the theme. For example, in case that the text input portion is a field that provides a function for inputting content of the email, text to be included in the text input portion may be a description of the media content. For example, the text input portion may identify a context or state represented through the media content from the information regarding the media content, identified through at least a portion of the operations exemplified through other sub-table of contents of the table of contents 1. The processor 110 may obtain the text including at least one word indicating or representing the context or the state. For example, a length of the text to be included in the text input portion, which is a field that provides a function for inputting content of the email, may be longer than a length of text to be included in the text input portion, which is a field that provides a function for inputting a title of the email. For example, a length of the text to be included in the text input portion, which is a field that provides a function for inputting content of the email, may be longer than a length of text to be included in the text input portion of a software application for transmitting and receiving a message.

Meanwhile, in case that a plurality of text input portions is displayed with the media content, such as in a user interface of a software application for email, the processor 110 may obtain text to be included in each of the plurality of text input portions. However, it is not limited thereto.

1. 14 Method for Obtaining Text Included in a Text Input Portion Displayed with a Plurality of Media Contents

For example, a plurality of media content may be displayed with the text input portion. For example, in case that the plurality of media contents is displayed with the text input portion, text to be included in the text input portion may indicate or represent common information of the plurality of media contents. For example, the processor 110 may identify categories of the plurality of media content, based on an event that displays the plurality of media content together with the text input portion. For example, the processor 110 may identify categories of first media content and identify categories of second media content, based on the event. For example, the categories of the first media content and the categories of the second media content may be identified through at least a portion of the operations exemplified through other sub-table of contents of the table of contents 1. For example, the categories of the first media content and the categories of the second media content may be identified based on processing executed before identifying the event or processing executed in response to the event. For example, the processor 110 may identify a common category of the first media content and the second media content through comparison between the categories of the first media content and the categories of the second media content. For example, the processor 110 may obtain the text based on the common category. For example, the processor 110 may identify that there is no common category of the first media content and the second media content through comparison between the categories of the first media content and the categories of the second media content. For example, the processor 110 may identify upper categories of the categories of the first media content and identify upper categories of the categories of the second media content, based on the identification. For example, the processor 110 may identify a common category through comparison between the upper categories regarding the first media content and the upper categories regarding the second media content. For example, the processor 110 may obtain the text based on the common category. However, it is not limited thereto.

### 1.15 Method of Obtaining Text Based on at Least a Portion of Items Respectively Indicating Identified Words Based on Information Regarding Media Content

For example, the processor 110 may identify the information regarding the media content through at least a portion of the operations exemplified through other sub-table of contents of the table of contents 1, and identify recommended words (e.g., keywords or categories) associated with the media content based on the information. For example, the processor 110 may display items respectively indicating the recommended words together with the text input portion. For example, the items may be adjacent to the text input portion. For example, the processor 110 may identify at least one word indicated by the at least one item, based on a user input for at least one item from among the items. For example, the processor 110 may obtain the text to be included in the text input portion based on the at least one word. However, it is not limited thereto.

### 1.16 Method of Obtaining Text by Arranging Identified Words Based on Information Regarding Media Content

For example, the processor 110 may identify the information regarding the media content through at least a portion of the operations exemplified through other sub-table of contents of the table of contents 1 and identify recommended words (e.g., keywords or categories) associated with the media content based on the information. For example, the processor 110 may obtain the text to be included in the text input portion by classifying the recommended words and arranging the recommended words according to a sentence format based on the classification. For example, the processor 110 may identify, among the recommended words, at least one first word indicating a place, at least one second word indicating a time, at least one third word indicating a context (or occasion), at least one fourth word indicating at least one user, and at least one fifth word indicating a type of the media content. For example, the processor 110 may obtain the text by arranging the recommended words in the order of the at least one first word, the at least second word, the third words, the at least one fourth word, and the at least one fifth word, in Korean language. For example, the processor 110 may arrange the third words in consideration of a sentence format. For example, the processor 110 may obtain the text, by arranging the third words in Korean language in the order of a word capable of being an adjective among the third words, a word capable of being an object among the third words, and a word capable of being a complement among the third words, in Korean language. For example, in case that the recommended words are “in the afternoon”, “photo”, “in Seoul”, “soup”, “delicious”, “Susan”, and “eating”, the processor 110 may obtain text, which is “In Seoul, in the afternoon, Susan eating delicious soup photo” in the exemplified order in Korean language. However, it is not limited thereto.

### 1.17 Method of Obtaining Another Text According to a Change in at Least a Portion of Text Obtained Through at Least a Portion of Operations Exemplified Through Other Sub-Table of Contents of the Table of Contents 1

For example, the processor 110 may display a text input portion including text obtained through at least a portion of the operations exemplified through other sub-table of contents of the table of contents 1. together with the media content. For example, the processor 110 may receive a user input for changing at least a portion of the text while displaying the text within the text input portion. For example, in response to a user input selecting at least one of words within the text, the processor 110 may identify candidate words replacing the at least one word from the information regarding the media content, identified through at least a portion of the operations exemplified through other sub-table of contents of the table of contents 1. For example, the processor 110 may display items respectively indicating the candidate words, together with the text input portion including the text including the at least one word selected by the user input. For example, the displayed items may be adjacent to the text input portion. For example, the processor 110 may change the at least one word into at least one other word indicated by the at least one item, in response to a user input for selecting at least one of the items. For example, the processor 110 may obtain text including the at least one other word replaced from the at least one word.

As described above, in case that the media content is displayed with the text input portion, the electronic device 100 may obtain the text to be included in the text input portion through at least a portion of the operations exemplified through the table of contents 1. For example, since obtaining the text may mean bypassing or refraining from at least a portion of obtaining the text through a text input means such as a virtual keyboard, the electronic device 100 may provide a service simplifying a user input for inputting the text through the text input means, via obtaining the text. For example, since a time when the user input for inputting the text through the text input means is received is reduced by obtaining the text, the electronic device 100 may provide faster responsiveness.

For example, the text obtained through at least a portion of the operations exemplified through the table of contents 1. may be displayed within the text input portion via various methods. For example, the processor 110 may display the text within the text input portion displayed with the media content, by executing at least a portion of operations to be exemplified through a table of contents “2. Method of displaying text within a text input portion” below. For example, the electronic device 100 may have an ability executing at least a portion of the operations exemplified through the table of contents “2. Method of displaying text within a text input portion” below.

2. Method of Displaying Text within a Text Input Portion
2.1 Method of Displaying Text within a Text Input Portion in Response to Obtaining Text

For example, the processor 110 may display the text within the text input portion, in response to obtaining the text through at least a portion of the operations exemplified through the table of contents 1. For example, the processor 110 may display the text within the text input portion before receiving a user input confirming that the text is displayed within the text input portion, in response to obtaining the text. In an embodiment, representation of the text may correspond to representation of the media content. For example, in case that the media content includes text, a font of the text displayed within the text input portion may correspond to a font of the text within the media content. For example, in case that the media content is an image, a color of the text displayed within the text input portion may correspond to a color of a visual object within the media content. However, it is not limited thereto.

2.2 Method of Displaying Text within a Text Input Portion after Displaying Items Indicating Candidate Texts

For example, the processor 110 may obtain a plurality of texts through at least a portion of the operations exemplified through the table of contents 1. For example, the processor 110 may display items respectively indicating the plurality of texts, before displaying the text within the text input portion. In response to a user input of selecting an item from among the items, the processor 110 may display text indicated by the item selected by the user input.

2.3 Method of Displaying Text within a Text Input Portion Together with Items Respectively Indicating Recommended Words

For example, in response to obtaining the text, the processor 110 may display items respectively indicating second words replacing first words in the text, together with the text input portion including the text. For example, in response to a user input selecting at least one of the items, the processor 110 may replace at least one word among the first words displayed in the text input portion with at least one other word indicated by the at least one user input.

In an embodiment, the items may be displayed based on a predetermined user input. For example, the processor 110 may display the text within the text input portion, in response to obtaining the text. For example, the processor 110 may identify third words associated with the word among the second words in response to a user input selecting one word in the text within the text input portion, and display items respectively indicating the third words. In an embodiment, in case that the items have a layer, the items may be displayed as a knowledge graph. For example, in case that the third words include a word indicating a first category and a word indicating a second category, which is an upper or lower category of the first category, the word indicating the first category and the word indicating the second category may be displayed as a knowledge graph. However, it is not limited thereto. Meanwhile, in response to a user input selecting at least one of the items, the processor 110 may replace at least one word among the first words displayed in the text input portion with at least one other word indicated by the at least one user input.

2.4 Method of Displaying Text within a Text Input Portion Together with an Item for Identifying Whether to Add at Least One Word Based on a User Input

For example, in response to obtaining the text, the processor 110 may display an item for identifying whether to add at least one word to the text, together with the text input portion including the text. For example, in response to a user input for the item, the processor 110 may display the text further including the at least one word indicated by the item within the text input portion. For example, the at least one word may include privacy information. However, it is not limited thereto. Meanwhile, displaying the item may be ceased. For example, displaying the item may be ceased, in response to the display of the text further including the at least one word, or the user input. For example, displaying the item may be ceased, in response to another user input confirming the text before the user input is received. For example, displaying the item may be ceased after a predetermined time has elapsed from a timing of displaying the item. However, it is not limited thereto.

2.5 Method of Processing Text Displayed within a Text Input Portion According to a Location of a Pointer

For example, the processor 110 may display the text input portion including the text in response to obtaining the text. For example, the text may be displayed with a pointer (e.g., a cursor) within the text input portion. For example, the processor 110 may cease displaying the text within the text input portion, according to a change in a location of the pointer. For example, the processor 110 may cease displaying the text within the text input portion, in response to a user input to move the pointer located at an end portion of the text to a beginning portion of the text. However, it is not limited thereto.

In an embodiment, a plurality of text input portions may be displayed with the media content within a user interface. For example, the processor 110 may display text obtained for the text input portion within a text input portion where the pointer is located among the plurality of text input portions. For example, remaining text input portions among the plurality of text input portions may be in an empty state, unlike the text input portion where the pointer is located. However, it is not limited thereto. For example, alternatively, the processor 110 may display a plurality of texts obtained respectively for the plurality of text input portions, within all the plurality of text input portions.

2.6 Method of Applying Text within a Text Input Portion to Another Portion

For example, the processor 110 may display the text input portion including the text, based on obtaining the text. For example, the processor 110 may receive a user input confirming the text while displaying the text input portion including the text. For example, in case that a user interface including the text input portion is a user interface of a software application for transmitting and receiving a message, the user input may be a touch input with respect to an executable object for transmitting the text to an external electronic device. For example, in case that a user interface including the text input portion is a software application for managing a schedule, the user input may be a touch input with respect to an executable object for storing a schedule or registering a schedule in a calendar. However, it is not limited thereto.

For example, the processor 110 may apply the text to another region (or portion) distinct from the text input portion, in response to the user input.

For example, the processor 110 may display the text within another region of the user interface having a function of changing information. For example, in case that the user interface is a user interface of a software application for a social network service, the processor 110 may display a tag including at least a portion of the text in the user interface.

For example, the processor 110 may apply the text outside the user interface. For example, the processor 110 may set a name of a file for the media content as at least a portion of the text. For example, the processor 110 may include at least a portion of the text in metadata of the media content. However, it is not limited thereto.

In an embodiment, obtaining the text through at least a portion of the operations exemplified through the table of contents 1. may be executed based on providing the media content from a first software application to a second software application that provides a user interface including the text input portion. For example, the media content may be provided to the second software application, in order to use at least one other function distinct from functions supported by the first software application. For example, the media content may be provided to the second software application for transmission to an external electronic device. However, it is not limited thereto.

For example, various inputs may be used to provide the media content from the first software application to the second software application.

For example, the processor 110 may provide the media content from the first software application to the second software application, based on an input with respect to an executable object in a user interface of the first software application. For example, the executable object, which is an object for providing the media content, may be an object for executing a function provided through a framework.

For example, in response to a user input moving the media content displayed within a user interface of the first software application to a user interface of a second software application displayed with the user interface of the first software application, the processor 110 may provide the media content from the first software application to the second software application. However, it is not limited thereto.

As described above, a method of obtaining text to be included in a text input portion displayed with media content and a method of displaying the text in the text input portion may be implemented as the following examples. However, it should be noted that combining of the above-described descriptions is not limited to the following examples.

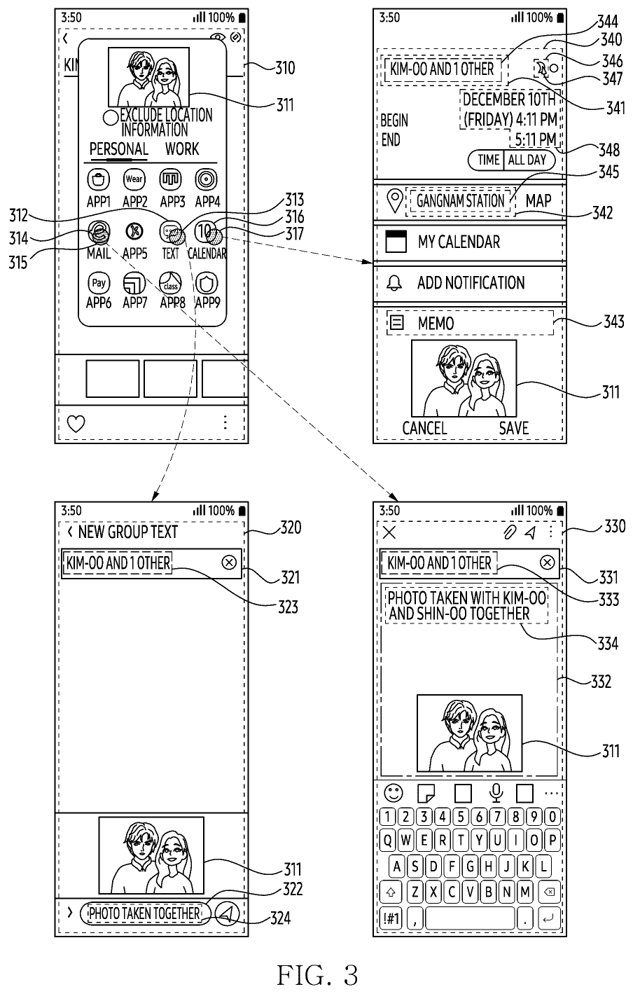

FIG. 3 illustrates an example of adaptively obtaining text included in a text input portion displayed with media content according to attribute information.

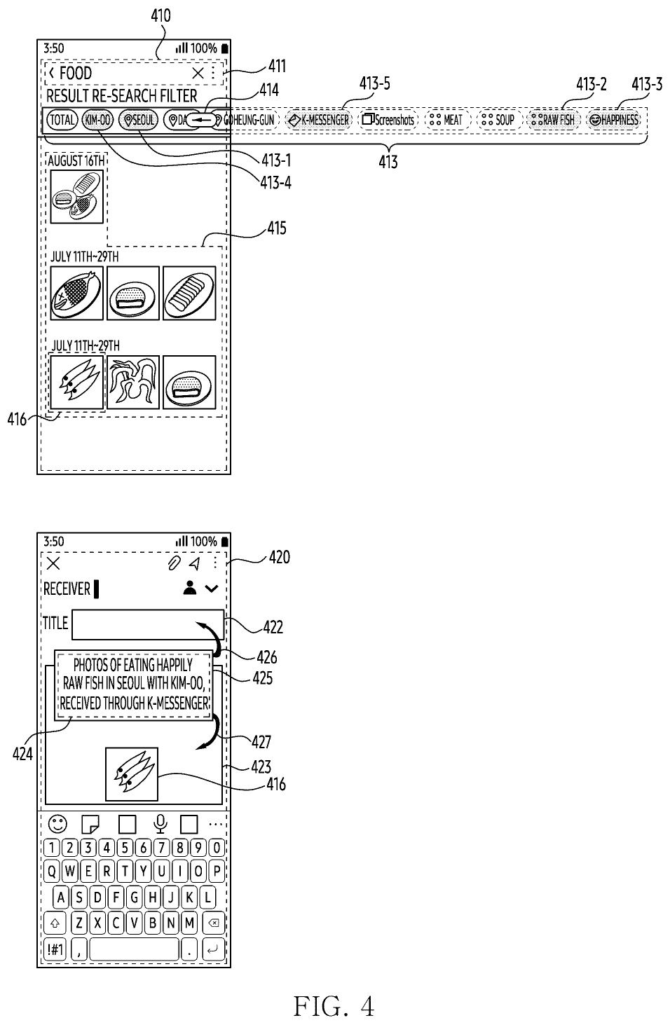

The user interfaces referring to FIG. 3 may be displayed through the display 140 of FIG. 1. It is for convenience of description that at least a portion of operations exemplified through FIG. 3 are not described in operations exemplified through FIGS. 4 to 19. At least a portion of the operations exemplified through FIG. 3 may be executed with the operations exemplified through FIGS. 4 to 19. However, it is not limited thereto.

Referring to FIG. 3, a processor 110 may identify an event for providing media content 311 identified through a user interface 310 of a first software application to manage a plurality of media content from the first software application to a second software application.

For example, the processor 110 may identify the event by identifying a user input 313 to an executable object 312 for executing the second software application, which is a software application for transmitting and receiving a message. In response to the event, the processor 110 may display a first text input portion 321 and a second text input portion 322 together with the media content 311 within a user interface 320 of the second software application. For example, the first text input portion 321 may include first text 323 obtained based on attribute information of the first text input portion 321. For example, the first text 323 may be obtained from a third software application for managing a contact. For example, the second text input portion 322 may include second text 324 obtained based on attribute information of the second text input portion 322. For example, the second text 324 may have a length identified based on the maximum number of characters capable of displaying within the second text input portion 322. For example, the second text 324 may indicate a context or state represented by the media content 311. For example, the second text 324 may be at least partially different from the first text 323. However, it is not limited thereto.

For example, the processor 110 may identify the event by identifying a user input 315 to an executable object 314 for executing the second software application, which is a software application for transmitting and receiving an email. In response to the event, the processor 110 may display a first text input portion 331 and a second text input portion 332 together with the media content 311 within a user interface 330 of the second software application. For example, the first text input portion 331 may include first text 333 obtained based on attribute information of the first text input portion 331. For example, the first text 323 may be obtained from a third software application for managing a contact. For example, since the first text 323 is obtained based on attribute information of the first text input portion 331, representation of the first text 333 corresponds to representation of the first text 323, but the first text 333 may be text for an email address and the first text 323 may be text for a phone number. For example, the second text input portion 332 may include second text 334 obtained based on attribute information of the second text input portion 332. For example, since the maximum number of characters capable of displaying within the second text input portion 332 is greater than the maximum number of characters capable of displaying within the second text input portion 322, the second text 334 may include more detailed information than the second text 324. For example, since a size of the second text input portion 332 is larger than a size of the second text input portion 322, the second text 334 may include more detailed information than the second text 324.

For example, the processor 110 may identify the event by identifying a user input 317 for an executable object 316 to execute the second software application, which is a software application for managing a schedule. In response to the event, the processor 110 may display a first text input portion 341, a second text input portion 342, and a third text input portion 343 together with the media content 311 within a user interface 340 of the second software application. For example, the first text input portion 341 may include first text 344 obtained based on attribute information of the first text input portion 341. For example, a length of the first text 344 may be identified based on a size of the first text input portion 341. For example, the first text 344 may be identified based on a context represented through the media content 311. For example, the second text input portion 342 may include second text 345 obtained based on attribute information of the second text input portion 342. For example, the second text 345 may be obtained by searching for a third software application for managing a location using a keyword obtained based on information regarding the media content 311. Although not shown in FIG. 3, the third text input portion 343 may include third text. In an embodiment, the processor 110 may change a state of another portion of the user interface 340 distinct from text input portions, based on information regarding the media content 311. For example, the processor 110 may identify that second data indicates the birthday of a user associated with the media content 311 from information regarding the media content 311 based on first data previously inputted to the second software application and second data inputted to a date field 348 of the user interface 340, and display a visual object 347 within a portion 346 representing a schedule to be registered through the user interface 340.

In an embodiment, the processor 110 may obtain data represented as shown in Table 1 below, by analyzing the media content 311 stored (or at least temporarily stored) in the electronic device 100.

TABLE 1

| Data type | Example |
|---|---|
| Text describing | Photo taken with Kim OO and Shin OO smiling |
| media content | together on their birthdays |
| Date | DECEMBER 10TH FRIDAY 4:11 PM |
| Place | GANGNAM STATION |
| Person | Kim OO and Shin OO |
| Emotion | Happy |
| Event type | party |
| Calorie | 300 Kcal |

In an embodiment, the processor 110 may predetermine information (e.g., text) to be included in a text input portion (or input portion) within a user interface of each of one or more software applications, based on the data represented as Table 1. For example, the predetermined information may be represented as shown in Table 2 below.

TABLE 2

| | First software | Second software | Third software | Fourth software |
|---|---|---|---|---|
| Category | application | application | application | application |
| Text input portion | Date when Kim | Kim OO and | Kim OO and | N/A |
| | OO and Shin OO | Shin OO took a | Shin OO took a | |
| | took a photo | photo together at | photo together at | |
| | | a birthday party | a birthday party | |
| | | on TGIF | on TGIF | |
| Date input portion | DECEMBER | N/A | N/A | DECEMBER |
| | 10TH FRIDAY | | | 10TH FRIDAY |
| | 4:11 PM | | | 4:11 PM |
| Place input portion | GANGNAM | N/A | N/A | N/A |
| | STATION | | | |
| User information | N/A | Kim OO | Kim OO (email), | N/A |
| input portion | | (message), | Shin OO (email) | |
| | | Shin OO | | |
| | | (message) | | |
| Emotion input portion | Smail Emotion | Smail Emotion | Smail Emotion | N/A |
| Event input portion | Party sticker | Smail Emotion | Smail Emotion | N/A |
| Calorie input portion | N/A | N/A | N/A | 300 kcal |

For example, in Table 2, the first software application may be a software application for managing a schedule, the second software application may be a software application for transmitting and receiving a message, the third software application may be a software application for transmitting and receiving an email, and the fourth software application may be a software application for health management. For example, text to be included in a text input portion of the first software application may be identified based on identifying that the first software application has a date input portion. For example, text to be included in a text input portion within each of the second software application and the third software application may be identified by changing date information of the data. However, it is not limited thereto.

As described above, the electronic device 100 may adaptively obtain text to be displayed in a text input portion, based on attribute information of the text input portion displayed together with media content. For example, through this adaptive obtainment, the electronic device 100 may provide different usage environments according to a type of software applications providing a user interface including a text input portion displayed with the media content.

FIG. 4 illustrates an example of obtaining text included in a text input portion based on resources used for searching media content.

The user interfaces illustrated in FIG. 4 may be displayed through the display 140 of FIG. 1. It is for convenience of description that at least a portion of operations exemplified through FIG. 4 are not described in operations exemplified through FIGS. 3 and 5 to 19. At least a portion of the operations exemplified through FIG. 4 may be executed together with the operations exemplified through FIGS. 3 and 5 to 19. However, it is not limited thereto.

Referring to FIG. 4, a processor 110 may identify media content through a user input to a user interface 410 of a first software application for managing a plurality of media content. For example, the processor 110 may receive a user input for inputting a search keyword 411 into a text input portion of the user interface 410. The processor 110 may display a plurality of media content identified based on the search keyword 411 in the user interface 410, in response to the user input. The processor 110 may display at least a portion of a plurality of items 413 respectively indicating categories of the plurality of media contents and/or keywords of the plurality of media contents, within the user interface 410. For example, at least another portion of the plurality of items 413, which are not displayed due to lack of a space in the user interface 410 allocated for the plurality of items 413 may be displayed in response to a swipe input (or sweeping input), such as the user input 414. For example, the processor 110 may receive a user input of selecting at least one item among the plurality of items 413. For example, the processor 110 may receive the user input for selecting an item 413-1, an item 413-2, an item 413-3, an item 413-4, and an item 413-5, from among the plurality of items 413. In response to the user input, the processor 110 may display, within the user interface 410, media content 415 corresponding to all of the item 413-1, the item 413-2, the item 413-3, the item 413-4, and the item 413-5 from among the plurality of items 413. The processor 110 may identify an event that provides media content 416 among the media content 415 to a second software application for transmitting and receiving an email. For example, based on the event, the processor 110 may identify words respectively represented by the item 413-1, the item 413-2, the item 413-3, the item 413-4, and the item 413-5, used to identify the media content 416. For example, the processor 110 may obtain text 424 to be included in at least a portion of a second text input portion 422 and a third text input portion 423 by arranging the words.

In an embodiment, the processor 110 may display the text 424 within the second text input portion 422, or display the text 424 within the third text input portion 423.

In an embodiment, the processor 110 may display a window 425 including the text 424, superimposed on the user interface 420, in response to obtaining the text 424. For example, the processor 110 may display the text 424 in the second text input portion 422, in response to a user input 426 that inserts the window 425 into the second text input portion 422. For example, the processor 110 may display the text 424 within the third text input portion 423, in response to a user input 427 that inserts the window 425 into the third text input portion 423.

As described above, the electronic device 100 may identify text to be included in a text input portion displayed together with media content, by using resources for searching for the media content. Since the identification of the text may simplify a user input for inputting the text, the electronic device 100 may provide an enhanced user experience. For example, in case that a plurality of text input portions is displayed together with media content, the electronic device 100 may provide an item for setting a location where the text 424 will be included, such as the window 425.

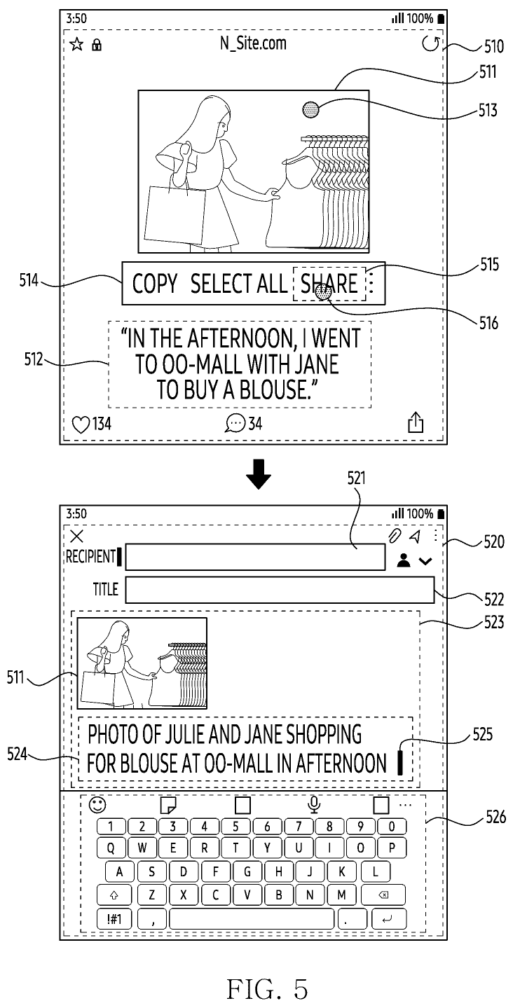

FIG. 5 illustrates an example of obtaining text included in a text input portion based on other media content displayed with media content.

The user interfaces illustrated in FIG. 5 may be displayed through the display 140 of FIG. 1. It is for convenience of explanation that at least a portion of the operations exemplified through FIG. 5 are not described in the operations exemplified through FIGS. 3, 4, and 6 to 19. At least a portion of the operations exemplified through FIG. 5 may be executed together with the operations illustrated through FIGS. 3, 4, and 6 to 19. However, it is not limited thereto.

Referring to FIG. 5, a processor 110 may display a user interface 510 of a first software application for processing a web page. The user interface 510 may include media content 511 and media content 512. For example, a type (e.g., text) of the media content 512 may be different from a type (e.g., image) of the media content 511. FIG. 5 illustrates an example in which the type of the media content 512 is different from the type of the media content 511, but the type of the media content 512 may be the same as the type of the media content 511. For example, the processor 110 may receive a user input 513 for selecting the media content 511. The processor 110 may display a window 514 superimposed on the user interface 510, in response to the user input 513. For example, the window 514 may include executable objects to respectively provide functions of a framework. The processor 110 may receive a user input 516 to an executable object 515 for providing the media content 511 from the first software application to a second software application, from among the executable objects within the window 514. The processor 110 may identify an event displaying a text input portion and the media content 511 within the user interface 520 of the second software application, which is a software application for transmitting and receiving an email, based at least in part on the user input 516. For example, the processor 110 may obtain text 524 to be included in the text input portion displayed together with the media content, based on the event. For example, the text 524 may be obtained based on the media content 512. In an embodiment, in response to obtaining the text 524, the processor 110 may identify that the text 524 is included in a third text input portion 523 based on attribute information of a first text input portion 521, a second text input portion 522, and a third text input portion 523 in the user interface 520. In an embodiment, the processor 110 may identify that the text 524 is included in the third text input portion 523, in response to a user input of selecting the third text input portion 523 among the first text input portion 521, the second text input portion 522, and the third text input portion 523. For example, the processor 110 may display the media content 511 within the user interface 520, together with the third text input portion 523 including the text 524. For example, the third text input portion 523 including the text 524, from among the first text input portion 521, the second text input portion 522, and the third text input portion 523, may further include a pointer 525. For example, the pointer 525 may be displayed in response to including the text 524 within the third text input portion 523 for correction of the text 524 or addition of a character to the text 524. In an embodiment, the processor 110 may display a virtual keyboard 526 superimposed on the user interface 520 for a character to be inputted from a location of the pointer 525. For example, the virtual keyboard 526 may be displayed based on a framework.

As described above, the electronic device 100 may identify text to be included in a text input portion displayed together with media content based on information regarding other media content adjacent to the media content. Since the fact that the other media content is adjacent to the media content may mean that the other media content is associated with the media content, the electronic device 100 may identify the text corresponding to a context indicated by the media content. For example, since the identification of the text may simplify a user input for inputting the text, the electronic device 100 may provide an enhanced user experience.

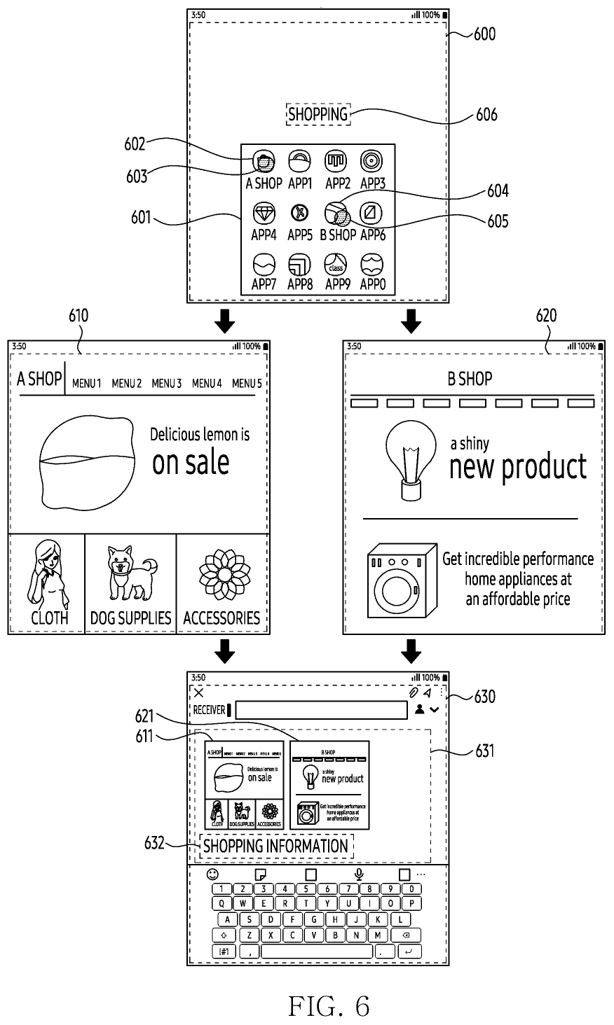

FIG. 6 illustrates an example of obtaining text included in a text input portion, based on a name of a folder including an executable object for executing a software application used to display media content.

The user interfaces illustrated in FIG. 6 may be displayed through the display 140 of FIG. 1. It is for convenience of explanation that at least a portion of the operations exemplified through FIG. 6 are not described in the operations exemplified through FIGS. 3 to 5, and 7 to 19. At least a portion of the operations exemplified through FIG. 6 may be executed together with the operations exemplified through FIGS. 3 to 5, and 7 to 19. However, it is not limited thereto.

Referring to FIG. 6, a processor 110 may display an executable object 602 for a first software application and an executable object 604 for a second software application in a folder 601 superimposed on a home screen 600. For example, the processor 110 may display the user interface 610 in response to the user input 603 for the executable object 602. For example, the processor 110 may obtain media content 611 including a captured image regarding at least a portion of the user interface 610. For example, the processor 110 may display a user interface 620, in response to a user input 605 for the executable object 604. For example, the processor 110 may obtain media content 621 including a captured image regarding at least a portion of the user interface 620. For example, the processor 110 may identify an event that provides the media content 611 from the first software application to a third software application for an email and the media content 621 from the second software application to the third software application. For example, the processor 110 may identify, based on the event, a name 606 of the folder 601 including the executable object 602 for the first software application used to provide the media content 611 and the executable object 604 for the second software application used to provide the media content 621. Based on the name 606, the processor 110 may identify text 632 to be included in a text input portion 631 displayed together with the media content 611 and the media content 621, within a user interface 630 of the third software application. The processor 110 may display text 632 within the text input portion 631.

As described above, the electronic device 100 may identify, based on a name of a folder including at least one executable object for at least one software application associated with at least one media content, text to be included in a text input portion displayed together with the at least one media content. Since the name of the folder may correspond to a service provided through the at least one software application, the text may correspond to the at least one media content. For example, since the identification of the text may simplify a user input for inputting the text, the electronic device 100 may provide an enhanced user experience.

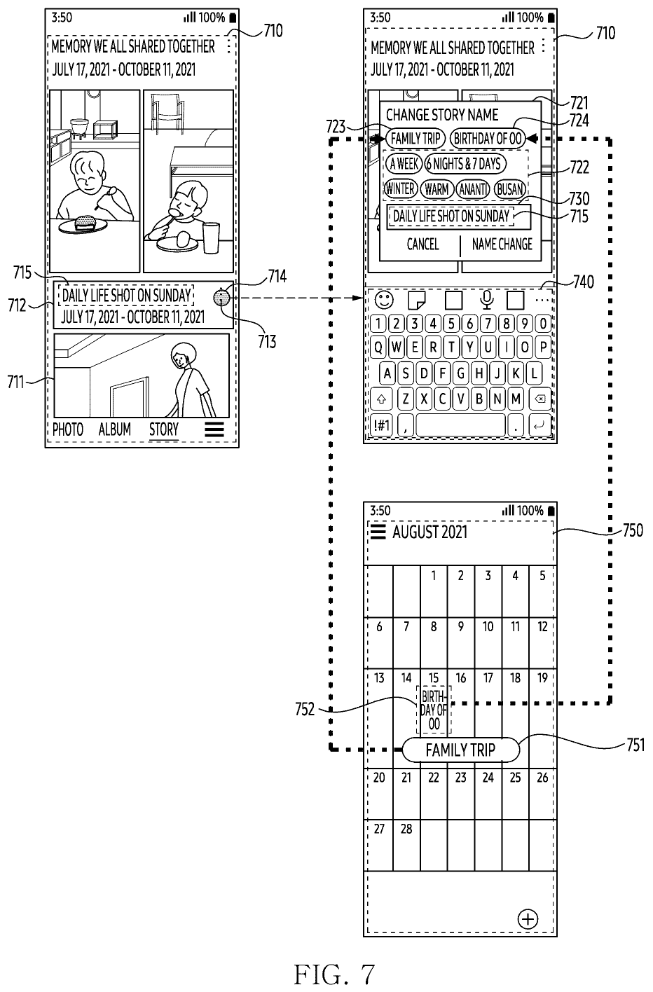

FIG. 7 illustrates an example of displaying a plurality of items associated with text in a text input portion displayed with media content.

The user interfaces illustrated in FIG. 7 may be displayed through the display 140 of FIG. 1. It is for convenience of explanation that at least a portion of the operations exemplified through FIG. 7 are not described in the operations exemplified through FIGS. 3 to 6, and FIGS. 8 to 19. At least a portion of the operations exemplified through FIG. 7 may be executed together with the operations exemplified through FIGS. 3 to 6, and 8 to 19. However, it is not limited thereto.

Referring to FIG. 7, a processor 110 may display integrated media content 711 including media content and information 712 indicating the media content 711, within a user interface 710 of a first software application for managing a plurality of media content. For example, the information 712 may include an executable element 713 for displaying executable objects (not shown in FIG. 7) to respectively provide functions associated with the integrated media content 711. Although not shown in FIG. 7, the executable objects may include an executable object for providing a function of changing text 715 (e.g., a title of the integrated media content 711) within the information 712. For example, the processor 110 may display the executable objects superimposed on the user interface 710, in response to a user input 714 for the executable element 713. The processor 110 may display a window 721 including a text input portion 730 for editing the text 715, in response to a user input for the executable object among the executable objects. For example, the window 721 may be superimposed on the user interface 710 including the integrated media content 711. For example, the windows 721 may include first items 722 indicating keywords (or categories) identified based on information regarding the integrated media content 711. For example, each of the first items 722 may be used to edit the text 715 within the text input portion 730. For example, in response to a user input for selecting an item of the first items 722, the processor 110 may add a keyword (or category) indicated by the item selected by the user input to the text 715 within the text input portion 730, and replace a word in the text 715 within the text input portion 730 with a keyword (or category) indicated by the item selected by the user input. For example, the window 721 may further include a second item 723 and a third item 724. For example, a keyword (or a category) indicated by the second item 723 and a keyword (or a category) indicated by the third item 724 may be identified by searching information obtained for a second software application distinct from the first software application based on the keywords (or categories) respectively indicated by the first items 722. For example, the keyword (or the category) indicated by the second item 723 and the keyword (or the category) indicated by the third item 724 may be obtained from information obtained for the second software application, which provides a user interface 750, for managing a schedule. For example, the keyword (or the category) indicated by the second item 723 may be identified from information 751 registered in the user interface 750, and the keyword (or the category) indicated by the third item 724 may be identified from information 752 registered in the user interface 750.

Although not shown in FIG. 7, the processor 110 may display the edited text 715 within the text input portion 730, based on a user input for at least one of the first items 722, the second item 723, and the third item 724. For example, editing the text 715 through the at least one item may be executed based on simplified user input rather than editing the text 715 through a virtual keyboard 740 superimposed on the user interface 710.

In an embodiment, the processor 110 may learn a pattern of a keyword (or category) used for editing the text 715, based on the user input for the at least one of the first items 722, the second item 723, and the third item 724. For example, based on a pattern identified based on the learning, the processor 110 may display a portion of the first items 722, the second item 723, and the third item 724 within the window 721, or visually highlight a portion of the first items 722, the second item 723, and the third item 724 within the window 721. For example, the processor 110 may display the first items 722, the second item 723, and the third item 724 within the window 721 in an arrangement corresponding to the pattern.

As described above, the electronic device 100 may provide an enhanced user experience through the display of the first items 722, the second item 723, and the third item 724. For example, since the electronic device 100 provides not only the first items 722 but also the second item 723 and the third item 724, the electronic device 100 may provide various options for the text 715.

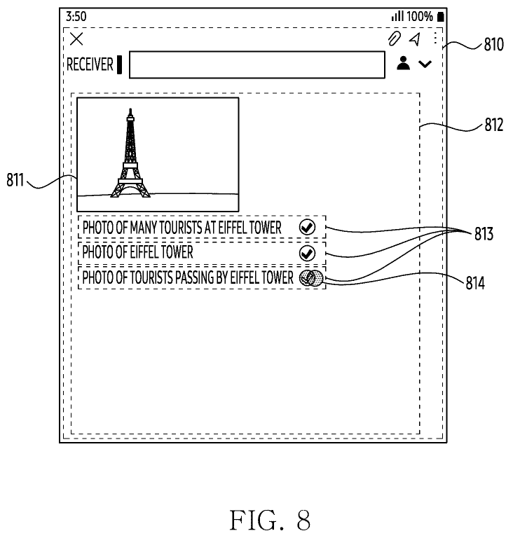

FIG. 8 illustrates an example of displaying a plurality of texts to be included in a text input portion.

The user interfaces illustrated in FIG. 8 may be displayed through the display 140 of FIG. 1. It is for convenience of explanation that at least a portion of the operations exemplified through FIG. 8 are not described in the operations exemplified through FIGS. 3 to 7, and 9 to 19. At least a portion of the operations exemplified through FIG. 8 may be executed together with the operations exemplified through FIGS. 3 to 7, and 9 to 19. However, it is not limited thereto.

Referring to FIG. 8, the processor 110 may display a user interface 810 of a software application for an email. For example, the user interface 810 may include media content 811 and a text input portion 812. For example, the text input portion 812 may include a plurality of items 813 respectively indicating a plurality of texts identified based on information regarding the media content 811. For example, the processor 110 may input text indicated by an item 814 into the text input portion 812, in response to a user input for the item 814 among the plurality of items 813. For example, the processor 110 may cease displaying the plurality of items 813, in response to the user input, and display the text within text input portion 812.

In an embodiment, the processor 110 may learn a usage pattern of the plurality of items 813, based on the user input. Based on the usage pattern identified based on the learning, the processor 110 may display a portion of the plurality of items 813 within the user interface 810, or may visually highlight a portion of the plurality of items 813 within the user interface 810. For example, the processor 110 may display the plurality of items 813 within the user interface 810 in an arrangement corresponding to the usage pattern. As described above, the electronic device 100 may provide an enhanced user experience through the display of the plurality of items 813.

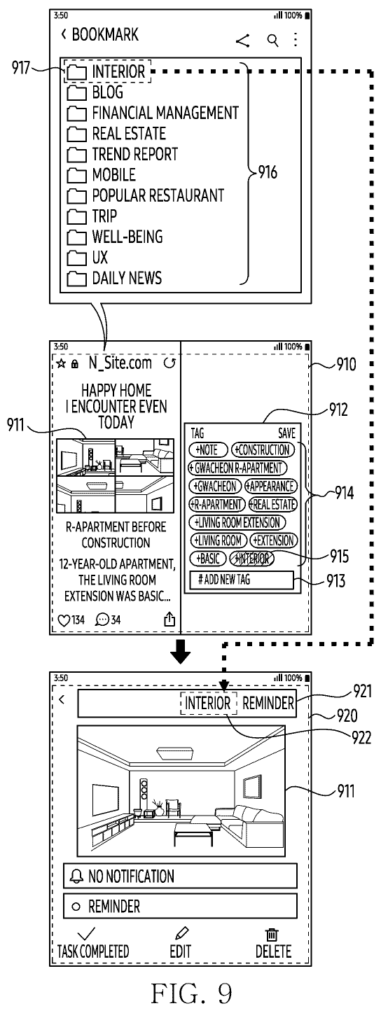

FIG. 9 illustrates an example of displaying an item for text in a text input portion based on a classification of a software application associated with media content.

The user interfaces illustrated in FIG. 9 may be displayed through the display 140 of FIG. 1. It is for convenience of explanation that at least a portion of the operations exemplified through FIG. 9 are not described in the operations exemplified through FIGS. 3 to 8, and 10 to 19. At least a portion of the operations exemplified through FIG. 9 may be executed together with the operations exemplified through FIGS. 3 to 8, and 10 to 19. However, it is not limited thereto.

Referring to FIG. 9, the processor 110 may display a user interface 910 of a first software application for a web page. For example, the user interface 910 may include media content 911 and a window 912. For example, the windows 912 may be used to apply a tag to the media content 911 provided from the first software application to a second software application for managing a plurality of media content. For example, the window 912 may include a text input portion 913 for inputting the tag. For example, the windows 912 may include items 914 respectively indicating keywords (or categories) identified based on information regarding the media content 911. For example, each of the items 914 may be used to set a tag to be inserted into the text input portion 913 as a word indicated by each of the items 914. For example, the items 914 may include an item 915. For example, the item 915 may be identified based on a name of a classification 917 including a webpage including the media content 911, from among classifications (e.g., bookmarks' folders 916) defined within the first software application. For example, since the name of the classification 917 is a word set according to the user's intention, and the webpage is included within the classification 917 having the name according to a user input, the name of the classification 917 including the webpage may correspond to a user intention for the media content 911. For example, since the name of the classification 917 corresponds to the user intention for the media content 911, the processor 110 may display the items 914 including the item 915 within the window 912.

For example, the name of the classification 917 may be applied to text to be included in a text input portion as well as objects displayed around the text input portion 913 such as the items 914. For example, the processor 110 may include the name of the classification 917 (e.g., interior 922) within text to be included in a text input portion 921 displayed with the media content 911 within a user interface 920 of a third software application for reminder.

Although not shown in FIG. 9, the name of the classification 917 may be used to classify the media content 911 within a software application including the media content 911 separated from the webpage, such as the second software application and the third software application. For example, the name of the classification 917 may be set as a tag for the media content 911, or may be set as a name of a file for the media content 911. However, it is not limited thereto.

As described above, the electronic device 100 may obtain text to be included in a text input portion displayed with media content included in a classification defined within a software application, based on a name of the classification. For example, the electronic device 100 may provide a service corresponding to a user intention by obtaining the text.

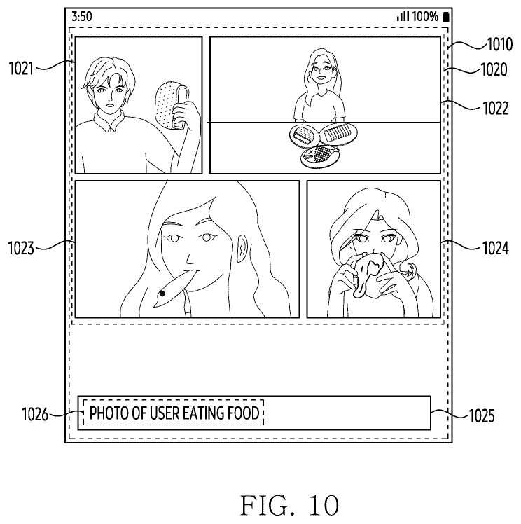

FIG. 10 illustrates an example of displaying text in a text input portion based on upper categories of categories of media content.

The user interfaces illustrated in FIG. 10 may be displayed through the display 140 of FIG. 1. It is for convenience of explanation that at least a portion of the operations exemplified through FIG. 10 are not described in the operations exemplified through FIGS. 3 to 9, and FIGS. 11 to 19. At least a portion of the operations exemplified through FIG. 10 may be executed together with the operations exemplified through FIGS. 3 to 9, and FIGS. 11 to 19. However, it is not limited thereto.

Referring to FIG. 10, a processor 110 may identify an event displaying media content 1020 and a text input portion 1025 within a user interface 1010. The processor 110 may identify categories (or keywords) of each of the media contents 1020 based on the event. For example, the processor 110 may identify categories of first media content 1021 among the media content 1020 as “steak”, “person”, and “photo”, based on visual objects of the first media content 1021 and a type of the first media content 1021. For example, the processor 110 may identify categories of second media content 1022 among the media content 1020 as “pork belly”, “person”, and “photo”, based on visual objects of the second media content 1022 and a type of the second media content 1022. For example, the processor 110 may identify categories of third media content 1023 among the media content 1020 as “seafood”, “person”, and “photo”, based on visual objects of the third media content 1023 and a type of the third media content 1023. For example, the processor 110 may identify categories of fourth media content 1024 among the media content 1020 as “chicken”, “person”, and “photo”, based on visual objects of the fourth media content 1024 and a type of the fourth media content 1024. For example, the processor 110 may identify common categories of the first media content 1021 to the fourth media content 1024 as “people” and “photo”, by comparing the first media content 1021 to the fourth media content 1024. For example, the processor 110 may identify an upper category of each of categories of the first media content 1021 to the fourth media content 1024, which are different. For example, based on the identification, the processor 110 may identify that the upper category of each of categories of the first media content 1021 to the fourth media content 1024, which are different, is “food”.

For example, the processor 110 may, based on the identifications, identify “food”, “person”, and “photo” as words to be included in the text input portion 1025. The processor 110 may display text 1026 obtained by arranging or disposing the words, within the text input portion 1025.

As described above, when a plurality of media content is displayed with a text input portion, the electronic device 100 may identify a common category and an upper category of categories of the plurality of media content, and identify text to be inserted into the text input portion based on the upper category and the common category. For example, since the text is identified based on the upper category and the common category, the text may correspond to each of the plurality of media contents.

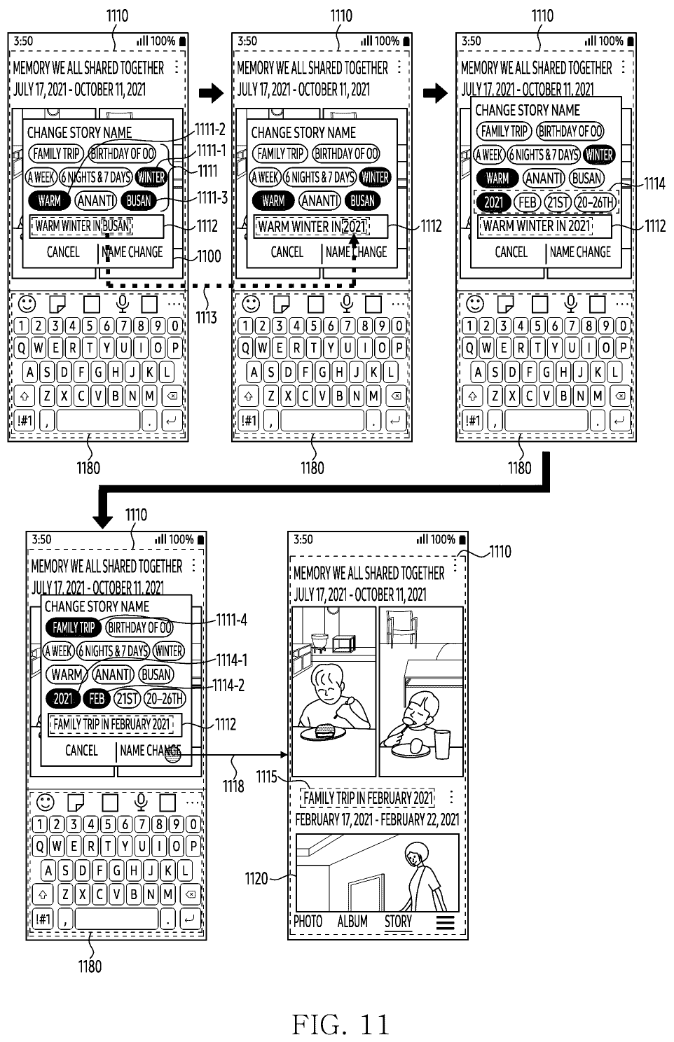

FIG. 11 illustrates an example of displaying additional items based on a change in text in a text input portion displayed with media content.

The user interfaces illustrated in FIG. 11 may be displayed through the display 140 of FIG. 1. It is for convenience of explanation that at least a portion of the operations exemplified through FIG. 11 are not described in the operations exemplified through FIGS. 3 to 10, and 12 to 19. At least a portion of the operations exemplified through FIG. 11 may be executed together with the operations exemplified through FIGS. 3 to 10, and 12 to 19. However, it is not limited thereto.

Referring to FIG. 11, a processor 110 may display a window 1100 for changing a title of media content 1120 within a user interface 1110 of a software application for managing a plurality of media content. For example, the window 1100 may include a text input portion 1112. For example, the windows 1100 may include a plurality of items 1111 respectively indicating a plurality of keywords (or a plurality of categories), identified based on information regarding the media content 1120. The processor 110 may display text (e.g., “warm winter of Busan”) within the text input portion 1112, in response to a user input for selecting a first item 1111-1, a second item 1111-2, and a third item 1111-3 among the plurality of items 1111. The processor 110 may receive a user input 1113 for changing the word “of Busan” within the text to “2021”. Although not shown in FIG. 11, the user input 1113 may be received through a virtual keyboard 1180. For example, the processor 110 may display modified text (e.g., “warm winter 2021”) in response to the user input 1113. For example, the processor 110 may additionally display, in the window 1100, items 1114 respectively indicating keywords associated with the word “2021” changed from the word “of Busan”. The processor 110 may receive a user input for selecting a fourth item 1111-4, a fifth item 1114-1, and a sixth item 1114-2 among the items 1114 and the plurality of items 1111. The processor 110 may display changed text (e.g., “family trip in February 2021”) within the text input portion 1112, in response to the user input. The processor 110 may receive a user input 1118 indicating that a title of the media content 1120 is changed based on the changed text. In response to the user input 1118, the processor 110 may display media content 1120 associated with a title 1115 including the changed text within the user interface 1110.

As described above, the electronic device 100 may enhance a user experience of changing text within a text input portion, by identifying additional keywords based on the changed word in text within the text input portion.

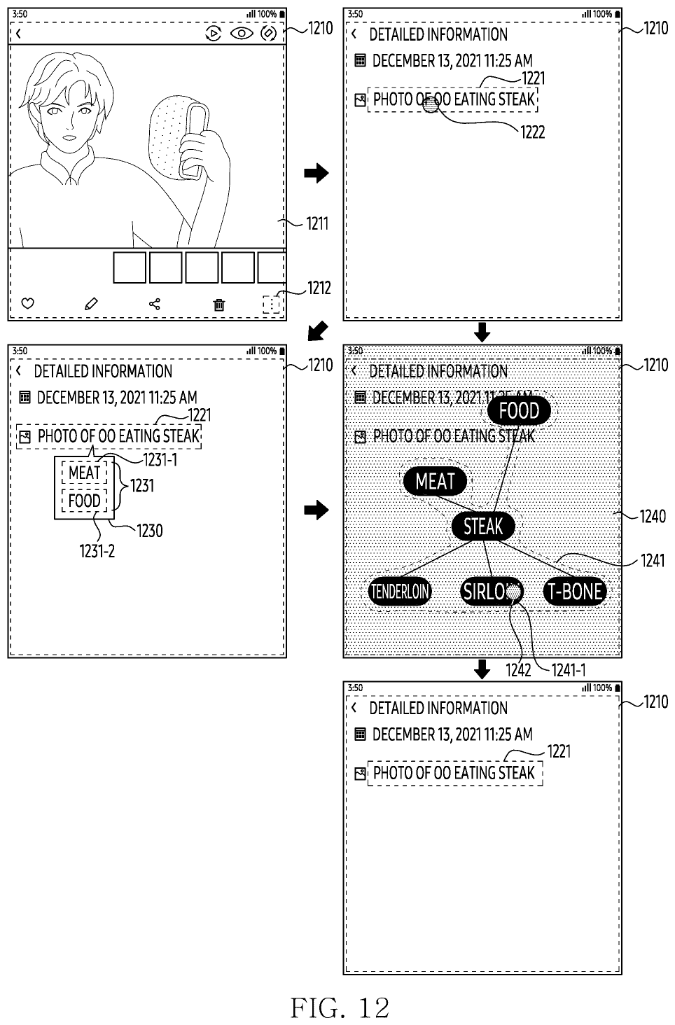

FIG. 12 illustrates an example of displaying items respectively indicating categories together with text in a text input portion.

The user interfaces illustrated in FIG. 12 may be displayed through the display 140 of FIG. 1. It is for convenience of explanation that at least a portion of the operations exemplified through FIG. 12 are not described in the operations exemplified through FIGS. 3 to 11, and 13 to 19. At least a portion of the operations exemplified through FIG. 12 may be executed together with the operations exemplified through FIGS. 3 to 11, and 13 to 19. However, it is not limited thereto.

Referring to FIG. 12, a processor 110 may display a user interface 1210 of a software application for managing a plurality of media contents. For example, the user interface 1210 may include media content 1211. For example, the processor 110 may identify an event displaying detailed information of the media content 1211. For example, the event may be identifying a touch input for an executable object in a window (not shown in FIG. 12) displayed through a user input for an executable object 1212. In response to the event, the processor 110 may display a field capable of editing the detailed information, and cease displaying the media content 1211. For example, the field may include a text input portion 1221. For example, since the text input portion 1221 is not displayed with the media content 1211 but the text input portion 1221 is displayed within the field providing the detailed information of the media content 1211, the text input portion 1221 may be associated with the media content 1211. For example, the processor 110 may receive a user input 1222 for a word (e.g., “steak”) in text within the text input portion 1221. For example, the user input 1222 may be an input for adding another word around the word or changing the word to another word. For example, the processor 110 may identify a category of the word, in response to the user input 1222. For example, the processor 110 may identify upper categories of the category and/or lower categories of the category, based on the identification. For example, the upper categories and/or the lower categories may be arranged such that a layer of each of the upper categories and/or a layer of each of the lower categories are represented. For example, each of the upper categories and/or the lower categories may be displayed in layer order. For example, the processor 110 may display a window 1230 based on the user input 1222. For example, the window 1230 may include items 1231 indicating the upper categories and/or the lower categories. For example, the items 1231 may be displayed as a list. For example, the items 1231 may be displayed within the window 1230 in layer order. For example, a second item 1231-2 indicating a category (e.g., food) upper than a category (e.g., meat) of the first item 1231-1 may be located under a first item 1231-1.

For example, the processor 110 may display a window 1240 based on the user input 1222. For example, the windows 1240 may include items 1241 indicating upper categories (e.g., meat and food) of a category of the word and lower categories (e.g., tenderloin, sirloin, and T-bone) of a category of the word. For example, the items 1241 may be displayed in the window 1240 in a form of a knowledge graph. For example, the processor 110 may receive a user input 1242 for the first item 1241-1 among the items 1241. The processor 110 may add another word (e.g., “sirloin”) corresponding to a category indicated by the first item 1241-1, in response to the user input 1242. For example, the processor 110 may display text to which the other word is added within the text input portion 1221.

As described above, in response to a user input for setting a word within a text input portion, the electronic device 100 may identify upper categories and/or lower categories of the word category identified by the user input. The electronic device 100 may simplify a user input for setting the word by displaying items indicating the upper categories and/or the lower categories as associated with the text input portion.

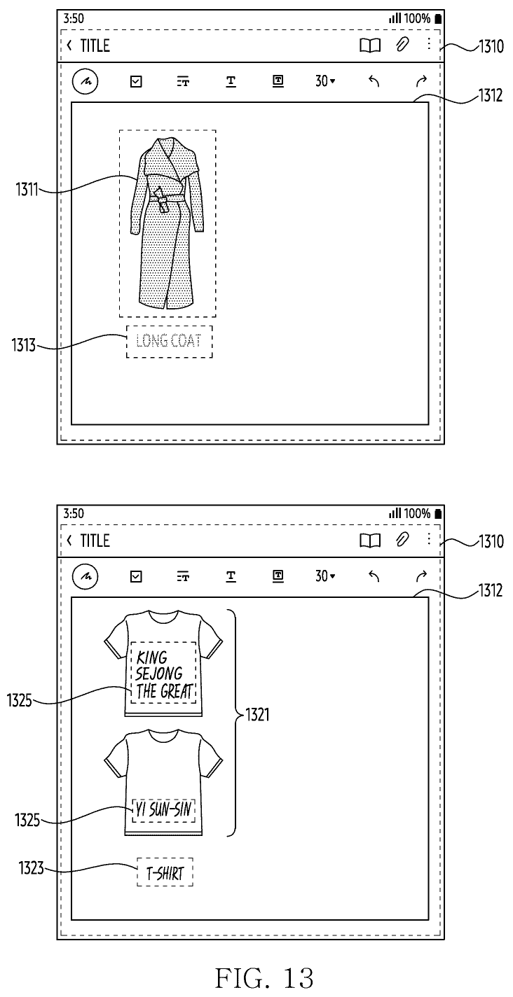

FIG. 13 illustrates an example of representation of text in a text input portion corresponding to representation of media content.

The user interfaces illustrated in FIG. 13 may be displayed through the display 140 of FIG. 1. It is for convenience of explanation that at least a portion of the operations exemplified through FIG. 13 are not described in the operations exemplified through FIGS. 3 to 12, and 14 to 19. At least a portion of the operations exemplified through FIG. 13 may be executed together with the operations exemplified through FIGS. 3 to 12, and 14 to 19. However, it is not limited thereto.

Referring to FIG. 13, a processor 110 may display a user interface 1310 of a software application for writing a memo. For example, the user interface 1310 may include a text input portion 1312 including media content 1311. For example, the processor 110 may display text 1313 identified based on information regarding the media content 1311 within the text input portion 1312. For example, representation of the text 1313 may be identified based on information regarding the media content 1311. For example, the representation of the text 1313 may correspond to representation of the media content 1311. For example, a color of the text 1313 may be red, which is a color of the media content 1311.

For example, the user interface 1310 may include the text input portion 1312 including media content 1321. For example, the processor 110 may display text 1323 identified based on information regarding the media content 1321 within the text input portion 1312. For example, representation of the text 1323 may be identified based on information regarding the media content 1321. For example, a font of the text 1323 may be cursive, which is a font of the text 1325 of the media content 1321.

As described above, the electronic device 100 may display text in a text input portion displayed with media content as representation corresponding to representation of the media content. The electronic device 100 may indicate association between the text and the media content through such a display.

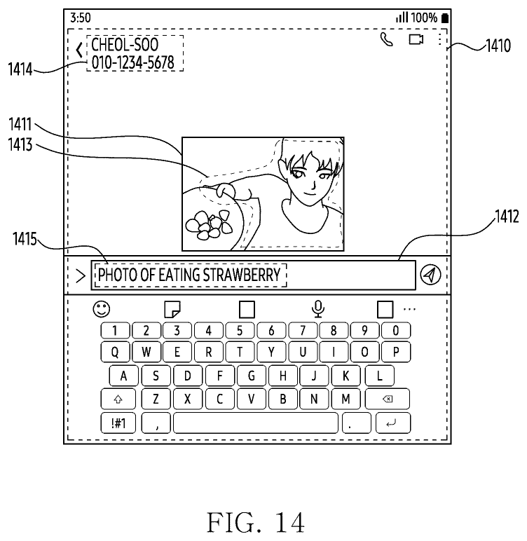

FIG. 14 illustrates an example of obtaining text based on a relationship between a user associated with media content and a user of an external electronic device.

The user interfaces illustrated in FIG. 14 may be displayed through the display 140 of FIG. 1. It is for convenience of explanation that at least a portion of the operations exemplified through FIG. 14 are not described in the operations exemplified through FIGS. 3 to 13, and 15 to 19. At least a portion of the operations exemplified through FIG. 14 may be executed together with the operations exemplified through FIGS. 3 to 13, and 15 to 19. However, it is not limited thereto.

Referring to FIG. 14, a processor 110 may display a user interface 1410 of a software application for transmitting and receiving a message. The user interface 1410 may include media content 1411 and a text input portion 1412. For example, the processor 110 may identify a user associated with the media content 1411, based on information regarding the media content 1411, in response to an event displaying the user interface 1410 including the media content 1411 and the text input portion 1412. For example, the processor 110 may identify a user corresponding to a visual object 1413 within the media content 1411. For example, in response to the event, the processor 110 may identify a recipient 1414 inputted to the user interface 1410 as a user of an external electronic device. For example, the processor 110 may identify a relationship between the user of the external electronic device and the user associated with the media content 1411. For example, the processor 110 may identify that the user of the external electronic device and the user associated with the media content 1411 are the same person. For example, the processor 110 may identify that the user of the external electronic device and the user associated with the media content 1411 are the same person, based on identifying that a visual object within other media content stored in association with the user of the external electronic device within another software application (e.g., a software application for a contact) corresponds to the visual object 1413 within the media content 1411. For example, the processor 110 may identify text 1415 to be included in the text input portion 1412 based on the identification. For example, the processor 110 may display the media content 1411 within the user interface 1410, together with the text input portion 1412 including the text 1415.

As described above, the electronic device 100 may identify, based on a relationship between a user associated with media content and a user of an external electronic device, text in a text input portion displayed with the media content. The electronic device 100 may display the text corresponding to a context within the text input portion, through such identification.

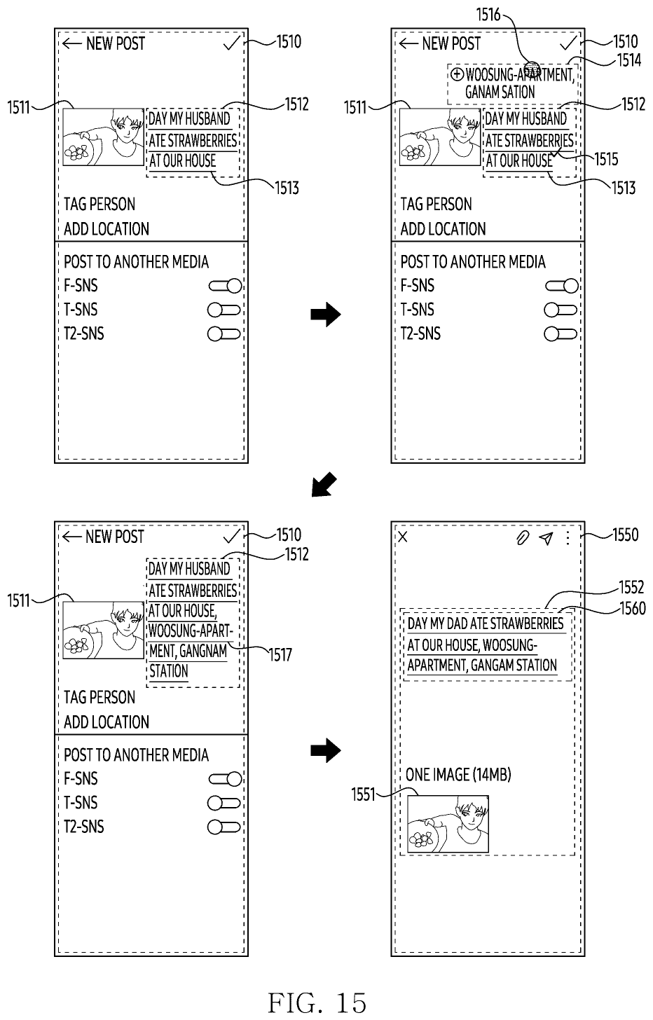

FIG. 15 illustrates an example of identifying whether to include privacy information in text to be included in a text input portion.

The user interfaces illustrated in FIG. 15 may be displayed through the display 140 of FIG. 1. It is for convenience of explanation that at least a portion of the operations exemplified through FIG. 15 are not described in the operations exemplified through FIGS. 3 to 14, and 16 to 19. At least a portion of the operations exemplified through FIG. 15 may be executed together with the operations exemplified through FIGS. 3 to 14, and 16 to 19. However, it is not limited thereto.

Referring to FIG. 15, a processor 110 may display a user interface 1510 of a software application for a social network service (SNS). For example, the user interface 1510 used to create information capable of being exposed to the outside may include media content 1511 and a text input portion 1512. For example, in response to an event displaying the user interface 1510 including the media content 1511 and the text input portion 1512, the processor 110 may identify text 1513 to be included in the text input portion 1512 based on information regarding the media content 1511. For example, the processor 110 may identify text 1513 from which privacy information has been removed, based on identifying that a service provided through the software application is a service requiring exposure to the outside. For example, the processor 110 may identify the text 1513 from which the address of a user of the electronic device 100 or a user associated with the media content 1511, which is privacy information, has been removed. The processor 110 may display the text input portion 1512 including the text 1513.

In an embodiment, the processor 110 may further display an object 1514 for identifying whether to include privacy information not included in the text 1513 around the text input portion 1512. For example, the object 1514 may represent or indicate at least one word (e.g., Woosung Apartment in Gangnam Station) including the privacy information. For example, the processor 110 may further display a visual element 1515 for guiding a location where the at least one word represented by the object 1514 is included. However, it is not limited thereto. The processor 110 may receive a user input 1516 for the object 1514. The processor 110 may display the text input portion 1512 including text 1517 further including the at least one word represented by the object 1514, in response to the user input 1516.

For example, the processor 110 may identify a function or a service of a software application that provides a user interface including the text input portion and the media content when obtaining the text to be included in the text input portion, and identify whether to include the privacy information within the text, based on the identification. For example, the processor 110 may identify text 1560 including the privacy information, in response to an event displaying the media content 1551 and the text input portion 1552 within a user interface 1550 of a software application providing information to a specific user, unlike the user interface 1510. For example, the processor 110 may identify text 1560 based on identifying that the recipient receiving an email including the text 1560 is the specific user. For example, the processor 110 may display a text input portion 1552 and media content 1551, which include the text 1560 including the privacy information within the user interface 1550.

As described above, the electronic device 100 may identify whether to disclose the privacy information according to a type of a software application, and identify text to be included in a text input portion displayed with media content based on the identification. The electronic device 100 may protect the user's privacy through such identification.

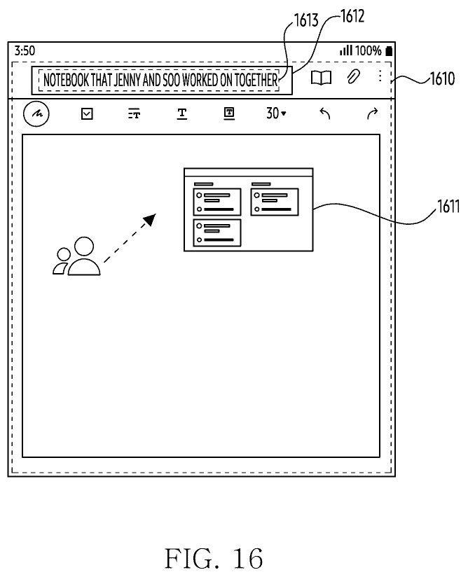

FIG. 16 illustrates an example of displaying text including information regarding a writer of media content in a text input portion.

The user interfaces illustrated in FIG. 16 may be displayed through the display 140 of FIG. 1. It is for convenience of explanation that at least a portion of the operations exemplified through FIG. 16 are not described in the operations exemplified through FIGS. 3 to 15, and 17 to 19. At least a portion of the operations exemplified through FIG. 16 may be executed together with the operations exemplified through FIGS. 3 to 15, and 17 to 19. However, it is not limited thereto.

Referring to FIG. 16, a processor 110 may identify an event displaying media content 1611 and a text input portion 1612 within a user interface 1610 for writing a document. In response to the event, the processor 110 may identify text 1613 to be included in the text input portion 1612 based on information regarding the media content 1611.

In an embodiment, text 1613 may include at least one word (e.g., “Jenny”, or “Jenny” and “Soo”) that indicates a writer of the media content 1611. For example, the processor 110 may obtain text 1613 including the at least one word indicating the writer of the media content 1611, based on metadata within the media content 1611. For example, the processor 110 may display the text input portion 1612 including the text 1613.

In an embodiment, the text 1613 may include a word indicating the writer (e.g., “Jenny”) of the media content 1611 and a word indicating a user (e.g., “Soo”) of the electronic device 100 including the user interface 1610. For example, the processor 110 may display the text input portion 1612 including the text 1613.

As described above, the electronic device 100 may enhance the convenience of managing a document, by including user information such as a writer of media content in text to be included in a text input portion displayed for a service associated with the document.

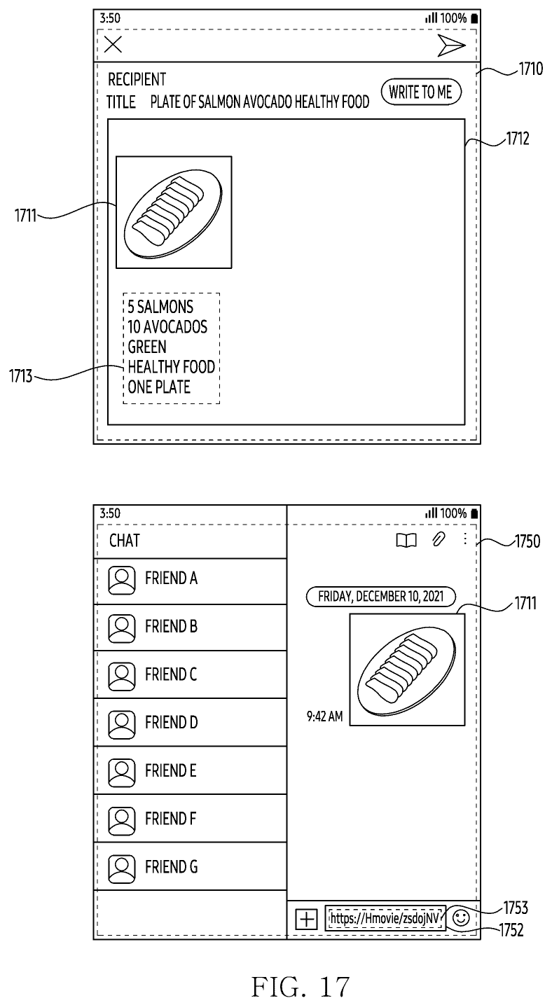

FIG. 17 illustrates an example of identifying a type of text to be included in a text input portion based on a type of a software application.

The user interfaces illustrated in FIG. 17 may be displayed through the display 140 of FIG. 1. It is for convenience of explanation that at least a portion of the operations exemplified through FIG. 17 are not described in the operations exemplified through FIGS. 3 to 16, 18, and 19. At least a portion of the operations exemplified through FIG. 17 may be executed together with the operations exemplified through FIGS. 3 to 16, 18, and 19. However, it is not limited thereto.

Referring to FIG. 17, in response to an event displaying media content 1711 and a text input portion 1712 within a user interface 1710, the processor 110 may identify text 1713 to be included in the text input portion 1712 based on a type of a first software application providing the user interface 1710. For example, the processor 110 may obtain the text 1713 configured with a non-executable object, based on identifying that the first software application supports a function of displaying a webpage only through a linkage with another software application. For example, the processor 110 may display the text input portion 1712 including the text 1713.

For example, in response to an event displaying media content 1711 and a text input portion 1752 within a user interface 1750, the processor 110 may identify text 1753 to be included in the text input portion 1752 based on a type of a second software application providing the user interface 1750. For example, the processor 110 may obtain text 1753 configured with an executable object for access to a webpage, based on identifying that the second software application supports a function of displaying a web page standalone. For example, the processor 110 may display the text input portion 1752 including the text 1753. For example, the text 1753 may be identified based on performing a web search based on information regarding the media content 1711. However, it is not limited thereto.

As described above, the electronic device 100 may adaptively change a type of text in a text input portion, according to a type of a software application. For example, the electronic device 100 may provide text having an attribute corresponding to a characteristic of a software application. For example, the electronic device 100 may identify the text through not only a result of recognition of media content, but also additional processing of the result of the recognition. For example, the electronic device 100 may provide various types of information through the text, through such identification.

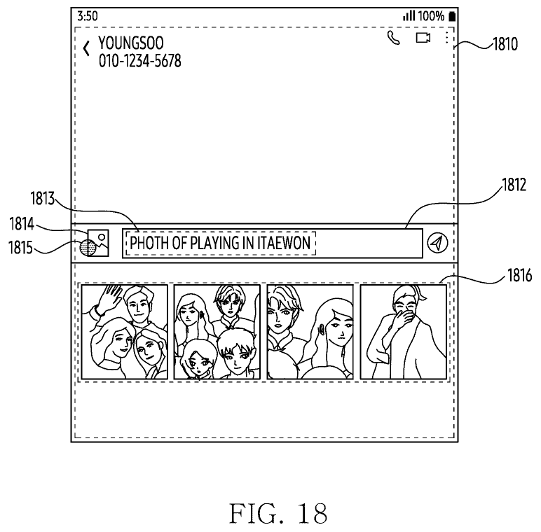

FIG. 18 illustrates an example of displaying media content corresponding to text included in a text input portion.

The user interfaces illustrated in FIG. 18 may be displayed through the display 140 of FIG. 1. It is for convenience of explanation that at least a portion of the operations exemplified through FIG. 18 are not described in the operations exemplified through FIGS. 3 to 17, and 19. At least a portion of the operations exemplified through FIG. 18 may be executed together with the operations exemplified through FIGS. 3 to 17, and 19. However, it is not limited thereto.

Referring to FIG. 18, the processor 110 may display a text input portion 1812 within a user interface 1810 of a first software application for transmitting and receiving a message. For example, the text input portion 1812 may include text 1813 inputted through a virtual keyboard (not shown in FIG. 18). For example, the user interface 1810 including the text input portion 1812 may include an executable object 1814 for executing a second software application distinct from the first software application. For example, the second software application may support a function that is not supported by the first software application. For example, the second software application may be a software application for managing a plurality of media contents. For example, the processor 110 may receive a user input 1815 for the executable object 1814 while the text input portion 1812 including the text 1813 is displayed. For example, the processor 110 may identify at least one media content 1816 corresponding to the text 1813 among the plurality of media content managed through the second software application executed in response to the user input 1815. For example, the processor 110 may display at least one media content 1816 within the user interface 1810. For example, the at least one media content 1816 may include a scene corresponding to content represented by the text 1813.

As described above, the electronic device 100 may provide not only obtaining text to be included in a text input portion displayed with media content based on the media content, but also obtaining media content to be displayed within a predetermined region based on the text included in the text input portion. For example, as described in FIG. 18, on a condition that a software application providing a user interface including the text input portion does not support a function of displaying media content, the electronic device 100 may execute obtaining the media contents to be displayed within the predetermined region of the user interface of the software application, by providing the text included in the text input portion to another software application having a function of managing the media contents as a search keyword. The electronic device 100 may provide an enhanced search service through such execution.

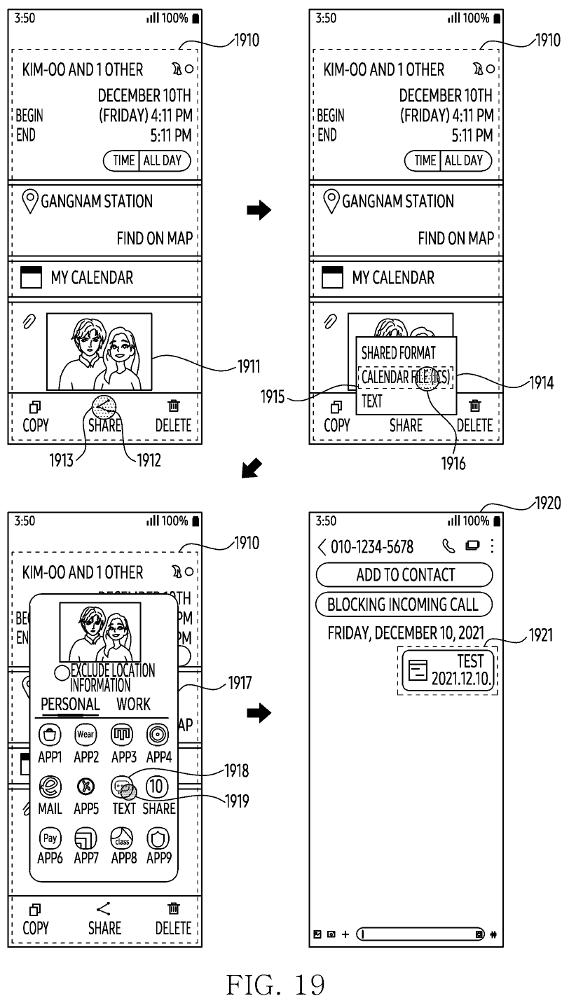

FIG. 19 illustrates an example of transferring information regarding media content to an external electronic device.

The user interfaces illustrated in FIG. 19 may be displayed through the display 140 of FIG. 1. It is for convenience of explanation that at least a portion of the operations exemplified through FIG. 19 are not described in the operations exemplified through FIGS. 3 to 18. At least a portion of the operations exemplified through FIG. 19 may be executed together with the operations exemplified through FIGS. 3 to 18. However, it is not limited thereto.

Referring to FIG. 19, a processor 110 may display schedule information including media content 1911 within a user interface 1910 of a first software application for managing a schedule. The user interface 1910 may include an executable object 1912 for a function of transmitting the schedule information to an external electronic device. For example, the processor 110 may display a window 1914 for identifying a format of the schedule information, including media content 1911, to be transmitted to the external electronic device, in response to a user input 1913 for an executable object 1912. For example, the processor 110 may receive a user input 1916 for an executable object 1915 indicating a first format (e.g., “calendar File (ICS)”) within the windows 1914. For example, the processor 110 may display a window 1917 to identify a second software application to be used to transmit the schedule information having the first format, in response to the user input 1916. For example, the window 1917 may be superimposed on the user interface 1910. For example, the window 1917 may be provided based on a framework. For example, the processor 110 may receive a user input 1919 for an executable object 1918 within the window 1917. For example, a second software application executed by the executable object 1918 may be a software application for transmitting and receiving a message. For example, the processor 110 may display a user interface 1920 of the second software application, which includes a visual object 1921 indicating that the schedule information having the first format is transmitted, in response to the user input 1919. For example, the processor 110 may transmit a portion of the schedule information having the first format to the external electronic device through the second software application executed in response to the user input 1919.

For example, data sets in the schedule information having the first format may include at least one first data set supported within the second software application and at least one second data set not supported within the second software application. For example, the at least one first data set may be transmitted to the external electronic device through the second software application, while the at least one second data set may not be transmitted to the external electronic device.

Meanwhile, the external electronic device may receive a portion of the schedule information including the at least one first data set using the second software application installed in the external electronic device. For example, the external electronic device may not receive another portion of the schedule information including the at least one second data set. For example, in response to a user input caused to the external electronic device, the external electronic device may register the portion of the schedule information in the first software application installed in the external electronic device, based on the at least one first data set. For example, the external electronic device may not receive the at least one second data set due to limitation of the second software application. For example, the external electronic device may not be able to completely transfer the schedule information registered in the electronic device 100.

For example, the processor 110 may identify a third software application that supports processing of the at least one second data set for the complete transfer of the schedule information, based on identifying that the second software application does not support processing of the at least one second data set. For example, in response to execution of the third software application, the processor 110 may transmit the at least one second data set to the external electronic device, based on the information regarding the external electronic device identified through the second software application. For example, the execution of the third software application may be in a background state, unlike the second software application executed in a foreground state. For example, the at least one second data set transmitted through the third software application may be transparent to a user.

Meanwhile, the external electronic device may receive the at least one second data set through the third software application installed in the external electronic device. The external electronic device may identify the at least one first data set received through the second software application and the at least one second data set received through the third software application based on a user input for registering the portion of the schedule information in the first software application installed in the external electronic device through the second software application installed in the external electronic device, and restore the schedule information to the schedule information registered in the electronic device 100 based on the identification. The external electronic device may completely register the schedule information in the first software application based on the restoration. However, it is not limited thereto.

As described above, on a condition that the second software application does not completely support transmission of information, which includes media content and text within a text input portion, registered through the first software application, the electronic device 100 may provide a complete transfer by assisting the second software application using the third software application.

The operations exemplified above may also be combined as follows.

According to an embodiment, an electronic device (e.g., the electronic device 100) may comprise a display and a processor. According to an embodiment, the processor may be configured to, based on a recognition of media content stored in the electronic device, obtain information regarding the media content. According to an embodiment, the processor may be configured to identify an event providing the media content from a first software application to a second software application. According to an embodiment, the processor may be configured to identify attribute information of a text input portion in a user interface of the second software application. According to an embodiment, the processor may be configured to obtain text indicating at least a portion of the information, based on the attribute information. According to an embodiment, the processor may be configured to display, via the display, a text input portion including the text, with the media content, in the user interface of the second software application executed in response to the event.

According to an embodiment, the attribute information may include data indicating that the text input portion is associated with a third software application different from the first software application and the second software application. According to an embodiment, the text may be obtained by searching, using the at least a portion of the information, a database stored in a storage region allocated for the third software application identified based on the data.

According to an embodiment, the attribute information may include data indicating a maximum number of characters capable of being input in the text input portion. According to an embodiment, the text may be obtained by identifying the at least a portion of the information based on the data.

According to an embodiment, the processor may be configured to identify, from among a plurality of visual objects, a visual object corresponding to at least another portion of the information. According to an embodiment, the processor may be configured to display, via the display, in the user interface, with the media content and the text input portion that includes the text, the visual object.

According to an embodiment, the processor may be configured to display, via the display, in a user interface of the first software application, the media content, with an executable object for a function provided via a framework. According to an embodiment, the processor may be configured to, based at least in part on an input on the executable object, identify the event. According to an embodiment, the processor may be configured to, using the second software application executed in response to the event, identify the attribute information. According to an embodiment, the processor may be configured to, using the second software application, obtain the text.

According to an embodiment, the processor may be configured to display, via the display, in a user interface of the first software application, items respectively indicating categories of the media content, with the media content identified from among a plurality of media contents stored in the electronic device.

According to an embodiment, the processor may be configured to, in response to the event identified while displaying the items with the media content, further based on at least a portion of the categories, obtain the text.

According to an embodiment, the processor may be configured to display, via the display, in a user interface of the first software application, with the media content, another text. According to an embodiment, the processor may be configured to, in response to the event identified while displaying the other text with the media content, further based on at least a portion of the other text, obtain the text.

According to an embodiment, the processor may be configured to, while displaying the media content in a user interface of the first software application, identify the event. According to an embodiment, the processor may be configured to, in response to the event, further based on a name of a folder including an executable object for executing the first software application used for displaying the media content, obtain the text.

According to an embodiment, the processor may be configured to identify that other information is at least partially associated with the information, the other information obtained via a third software application before the event is identified. According to an embodiment, the processor may be configured to, further based on the other information, obtain the text.

According to an embodiment, the processor may be configured to identify that another information is at least partially associated with the information, the other information obtained via a third software application before the event is identified. According to an embodiment, the processor may be configured to display, via the display, in the user interface of the second software application executed in response to the event, with the media content, items respectively indicating keywords identified based on the text input portion including the text, and the other information. According to an embodiment, the processor may be configured to receive a user input regarding at least one item from among the items. According to an embodiment, the processor may be configured to, in response to the user input, based on at least one keyword indicated by the at least one item, change at least a portion of the text displayed in the user interface.

According to an embodiment, the processor may be configured to display, via the display, in a user interface of the first software application, items respectively indicating categories of a plurality of media contents stored in the electronic device and at least a portion of the plurality of media contents. According to an embodiment, the processor may be configured to identify the event while the media content, identified from among the plurality of media contents based on a user input regarding at least one item from among the items, is displayed in the user interface of the first software application. According to an embodiment, the processor may be configured to, based on the event, obtain the text further based on at least one category indicated by the at least one item.

According to an embodiment, the at least one item selected by the user input may be visually highlighted relative to remaining items from among the items.

According to an embodiment, the processor may be configured to obtain the information by identifying categories of objects in the media content through the recognition of the media content. According to an embodiment, the processor may be configured to identify, from among the categories, a category including the largest number of objects. According to an embodiment, the processor may be configured to, further based on the identified category, obtain the text.

According to an embodiment, the processor may be configured to, based on the recognition of the media content, obtain the information including data regarding at least one object included in a predetermined region from among objects in the media content. According to an embodiment, the processor may be configured to, further based on the data regarding the at least one object, obtain the text.

According to an embodiment, the processor may be configured to, while displaying, in a user interface of the first software application, the media content included in a classification from among classifications used in the first software application. According to an embodiment, the processor may be configured to, further based on a name of the classification including the media content, obtain the text.

According to an embodiment, the processor may be configured to identify the event providing the media content and other media content from the first software application to the second software application. According to an embodiment, the processor may be configured to identify first text for the media content based on the information. According to an embodiment, the processor may be configured to identify second text for the other media content, based on other information obtained based on recognition of the other media content. According to an embodiment, the processor may be configured to identify an upper category including a category including a word in the first text and a category including a word in the second text. According to an embodiment, the processor may be configured to obtain the text including at least a portion of the information and at least a portion of the other information, further based on the upper category. According to an embodiment, the processor may be configured to display the text input portion including the text, together with the media content and the other media content, through the display, within the user interface of the second software application.

According to an embodiment, the processor may be further configured to display items respectively indicating the text input portion including the text and keywords identified based on the information, through the display, in the user interface of the second software application. According to an embodiment, the processor may be further configured to display at least one item indicating at least one keyword indicating the changed portion of the text through the display together with the items, in response to a second user input for changing a portion of the text. According to an embodiment, the processor may be further configured to display other text within the text input portion through the display, based on the at least one item and a second user input for selecting at least a portion of the items.

According to an embodiment, the processor may be further configured to receive a first user input for selecting a word of the words in the text displayed in the user interface of the second software application. According to an embodiment, the processor may be further configured to display items respectively indicating a category of the word, an upper category of the category, and a lower category of the category through the display, within the user interface of the second software application. According to an embodiment, the processor may be further configured to display the text in which the word is changed into at least another word, through the display within the text input portion, in response to a second user input for at least one of the items.

According to an embodiment, the electronic device may further include communication circuitry. According to an embodiment, the second software application may be a software application usable to transmit the media content to an external electronic device. According to an embodiment, the second software application may be a software application that does not provide a function of processing at least another portion of the information different from the at least a portion of the information. According to an embodiment, the processor may be further configured to transmit the at least another portion of the information to the external electronic device through the communication circuitry, by using a third software application. According to an embodiment, when the media content is provided from the second software application to the third software application or a fourth software application within the external electronic device, the at least another portion of the information may be transmitted from the electronic device to provide the at least another portion of the information within the external electronic device.

According to an embodiment, the user interface of the second software application may include the text input portion and another text input portion. According to an embodiment, the processor may be further configured to obtain the text, based on identifying that the text input portion from among the text input portion and the other text input portion is focused in response to the event. According to an embodiment, the processor may be further configured to obtain other text indicating at least a portion of the information based on attribute information of the other text input portion, in response to a user input of moving a pointer of the text input portion to the other text input portion while displaying the user interface of the second software application including the text input portion, the text input portion including the text. According to an embodiment, the processor may be further configured to display the other text input portion including the other text through the display within the user interface of the second software application.

According to an embodiment, representation of the text may correspond to representation of the media content or representation of an object in the media content.

According to an embodiment, the second software application may be a software application usable to transmit the media content to an external electronic device. According to an embodiment, the processor may be configured to obtain the information including data regarding a first user associated with the media content, based on the recognition of the media content. According to an embodiment, the processor may be configured to obtain data regarding a second user associated with the external electronic device. According to an embodiment, the processor may be configured to identify a word indicating the first user based on a relationship between the first user and the second user. According to an embodiment, the processor may be configured to obtain the text including the word.

According to an embodiment, the second software application may be a software application usable to transmit the media content to an external electronic device. According to an embodiment, the processor may be configured to identify the at least a portion of the information, further based on excluding privacy data from the information.

According to an embodiment, the processor may be further configured to display an item for including other text indicating the privacy data within the text input portion through the display within the user interface of the second software application, together with the text input portion including the text. According to an embodiment, the processor may be further configured to display the text input portion further including the other text through the display within the user interface of the second software application, in response to a user input for the item, and cease displaying the item within the user interface of the second software application.

According to an embodiment, the processor may be configured to identify a service provided through the second software application in response to the event. According to an embodiment, the processor may be configured to obtain the text further based on the service.

According to an embodiment, the processor may be further configured to identify another event of displaying a plurality of items respectively indicating a plurality of media contents stored in the electronic device, while displaying the text input portion including the text within the user interface of the second software application. According to an embodiment, the processor may be further configured to identify at least one media content associated with at least one word in the text among the plurality of media content. According to an embodiment, the processor may be further configured to display at least one item indicating the at least one media content through the display within a region displayed in response to the other event.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine (e.g., the electronic device 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising computer-executable instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory comprising one or more storage media storing one or more computer programs; and
one or more processors comprising processing circuitry,
wherein the one or more computer programs include computer-executable instructions that, when executed by the one or more processors individually or collectively, cause the electronic device to:
based on a recognition of media content stored in the electronic device, obtain information regarding the media content,
identify an event providing the media content from a first software application to a second software application,
identify attribute information of a text input portion in a user interface of the second software application,
obtain text indicating at least a portion of the information, based on the attribute information, and
display, via the display, a text input portion including the text, with the media content, in the user interface of the second software application executed in response to the event.

2. The electronic device of claim 1,
wherein the attribute information includes data indicating that the text input portion is associated with a third software application different from the first software application and the second software application, and
wherein the text is obtained by searching, using the at least a portion of the information, a database stored in a storage region allocated for the third software application identified based on the data.

3. The electronic device of claim 1,
wherein the attribute information includes data indicating a maximum number of characters capable of being input in the text input portion, and
wherein the text is obtained by identifying the at least a portion of the information based on the data.

4. The electronic device of claim 1, wherein the one or more computer programs further include computer-executable instructions that, when executed by the one or more processors individually or collectively, cause the electronic device to:
identify, from among a plurality of visual objects, a visual object corresponding to at least another portion of the information; and
display, via the display, in the user interface, with the media content and the text input portion that includes the text, the visual object.

5. The electronic device of claim 1, wherein the one or more computer programs further include computer-executable instructions that, when executed by the one or more processors individually or collectively, cause the electronic device to:
display, via the display, in a user interface of the first software application, the media content, with an executable object for a function provided via a framework;
based at least in part on an input on the executable object, identify the event;
using the second software application executed in response to the event, identify the attribute information; and
using the second software application, obtain the text.

6. The electronic device of claim 1, wherein the one or more computer programs further include computer-executable instructions that, when executed by the one or more processors individually or collectively, cause the electronic device to:
display, via the display, in a user interface of the first software application, items respectively indicating categories of the media content, with the media content identified from among a plurality of media contents stored in the electronic device; and
in response to the event identified while displaying the items with the media content, further based on at least a portion of the categories, obtain the text.

7. The electronic device of claim 1, wherein the one or more computer programs further include computer-executable instructions that, when executed by the one or more processors individually or collectively, cause the electronic device to:
display, via the display, in a user interface of the first software application, with the media content, another text; and
in response to the event identified while displaying the another text with the media content, further based on at least a portion of the another text, obtain the text.

8. The electronic device of claim 1, wherein the one or more computer programs further include computer-executable instructions that, when executed by the one or more processors individually or collectively, cause the electronic device to:
while displaying the media content in a user interface of the first software application, identify the event; and
in response to the event, further based on a name of a folder including an executable object for executing the first software application used for displaying the media content, obtain the text.

9. The electronic device of claim 1, wherein the one or more computer programs further include computer-executable instructions that, when executed by the one or more processors individually or collectively, cause the electronic device to:
identify that another information is at least partially associated with the information, the another information obtained via a third software application before the event is identified; and
further based on the another information, obtain the text.

10. The electronic device of claim 1, wherein the one or more computer programs further include computer-executable instructions that, when executed by the one or more processors individually or collectively, cause the electronic device to:
identify that another information is at least partially associated with the information, the another information obtained via a third software application before the event is identified;
display, via the display, in the user interface of the second software application executed in response to the event, with the media content, items respectively indicating keywords identified based on the text input portion including the text, and the another information;
receive a user input regarding at least one item from among the items; and
in response to the user input, based on at least one keyword indicated by the at least one item, change at least a portion of the text displayed in the user interface.

11. The electronic device of claim 1, wherein the one or more computer programs further include computer-executable instructions that, when executed by the one or more processors individually or collectively, cause the electronic device to:
display, via the display, in a user interface of the first software application, items respectively indicating categories of a plurality of media contents stored in the electronic device and at least a portion of the plurality of media contents;
identify the event while the media content, identified from among the plurality of media contents based on a user input regarding at least one item from among the items, is displayed in the user interface of the first software application; and
based on the event, obtain the text further based on at least one category indicated by the at least one item.

12. The electronic device of claim 11, wherein the at least one item selected by the user input is visually highlighted relative to remaining items from among the items.

13. The electronic device of claim 1, wherein the one or more computer programs further include computer-executable instructions that, when executed by the one or more processors individually or collectively, cause the electronic device to:
obtain the information by identifying categories of objects in the media content through the recognition of the media content;
identify, from among the categories, a category including a largest number of objects; and
further based on the identified category, obtain the text.

14. The electronic device of claim 1, wherein the one or more computer programs further include computer-executable instructions that, when executed by the one or more processors individually or collectively, cause the electronic device to:
based on the recognition of the media content, obtain the information including data regarding at least one object included in a predetermined region from among objects in the media content; and
further based on the data regarding the at least one object, obtain the text.

15. The electronic device of claim 1, wherein the one or more computer programs further include computer-executable instructions that, when executed by the one or more processors individually or collectively, cause the electronic device to:
while displaying, in a user interface of the first software application, the media content included in a classification from among classifications used in the first software application; and
further based on a name of the classification including the media content, obtain the text.

16. The electronic device of claim 1, wherein the one or more computer programs further include computer-executable instructions that, when executed by the one or more processors individually or collectively, cause the electronic device to:
identify the event providing the media content and another media content from the first software application to the second software application;
identify first text for the media content based on the information;
identify second text for the other media content, based on other information obtained based on recognition of the other media content;
identify an upper category including a category including a word in the first text and a category including a word in the second text;
obtain the text including at least a portion of the information and at least a portion of the other information, further based on the upper category; and
display the text input portion including the text, together with the media content and the other media content, through the display, within the user interface of the second software application.

17. The electronic device of claim 1, wherein the one or more computer programs further include computer-executable instructions that, when executed by the one or more processors individually or collectively, cause the electronic device to:
display items respectively indicating the text input portion including the text and keywords identified based on the information, through the display, in the user interface of the second software application;
display at least one item indicating at least one keyword indicating a changed portion of the text through the display together with the items, in response to a second user input for changing a portion of the text; and
display other text within the text input portion through the display, based on the at least one item and a second user input for selecting at least a portion of the items.

18. The electronic device of claim 1, wherein the one or more computer programs further include computer-executable instructions that, when executed by the one or more processors individually or collectively, cause the electronic device to:
receive a first user input for selecting a word of the words in the text displayed in the user interface of the second software application;
display items respectively indicating a category of the word, an upper category of the category, and a lower category of the category through the display, within the user interface of the second software application; and
display the text in which the word is changed into at least another word, through the display within the text input portion, in response to a second user input for at least one of the items.

19. A method executed in an electronic device with a display, the method comprising:
based on a recognition of media content stored in the electronic device, obtaining information regarding the media content,
identifying an event providing the media content from a first software application to a second software application,
identifying attribute information of a text input portion in a user interface of the second software application,
obtaining text indicating at least a portion of the information, based on the attribute information, and
displaying, via the display, a text input portion including the text, with the media content, in the user interface of the second software application executed in response to the event.

20. One or more non-transitory computer-readable storage media storing one or more computer programs including computer-executable instructions that, when executed by one or more processors of an electronic device individually or collectively, cause the electronic device to perform operations, the operations comprising:
based on a recognition of media content stored in the electronic device, obtain information regarding the media content,
identify an event providing the media content from a first software application to a second software application,
identify attribute information of a text input portion in a user interface of the second software application,
obtain text indicating at least a portion of the information, based on the attribute information, and
display, via the display, a text input portion including the text, with the media content, in the user interface of the second software application executed in response to the event.
